(19) United States
(12) Patent Application Publication
(10) Pub. No.: US 2014/0270897 A1
(43) Pub. Date: Sep. 18, 2014

(54) FLUID APPLICATORS FOR USE WITH TOPICAL MEDICATIONS

(71) Applicant: ABBVIE INC., NORTH CHICAGO, IL (US)

(72) Inventors: Linas P. Laurusonis, Gurnee, IL (US); Edward Naguit Abante, Chicago, IL (US); Bryan Eliot Rolfs, Chicago, IL (US); Ramana Malladi, Vernon Hills, IL (US); Bhimaprasad Medhal, Vernon Hills, IL (US); James Blaine Wolford, Chicago, IL (US); Olivier Franck Currat, Chicago, IL (US); Martin Rathgeber, Chicago, IL (US); Kieron Hiuhon Tse, Mt. Prospect, IL (US)

(73) Assignee: ABBVIE INC., NORTH CHICAGO, IL (US)

(21) Appl. No.: 14/212,229

(22) Filed: Mar. 14, 2014

Related U.S. Application Data
(60) Provisional application No. 61/791,898, filed on Mar. 15, 2013.

(51) Int. Cl. B05C 1/00

(52) U.S. Cl. CPC B05C 1/00
USPC 401/146

(57) ABSTRACT

Fluid applicators for use with topical medications are disclosed herein. An example apparatus includes a housing and a fluid container disposed inside the housing. The example apparatus also includes a pump assembly disposed inside the housing and fluidly coupled to the fluid container. The example apparatus further includes an applicator coupled to the housing. The applicator defines an outlet and has a surface to be in contact with an application site on a person. The surface is in fluid communication with the pump assembly via the outlet. The example apparatus also includes an actuator operatively coupled to the pump assembly. Movement of the actuator from a first position to a second position is to operate the pump to dispense a dose of the fluid onto the surface.

### RELATED APPLICATION

This patent claims priority to U.S. Provisional Application Ser. No. 61/791,898, which was filed on Mar. 15, 2013 and is hereby incorporated herein by reference in its entirety.

### FIELD OF THE DISCLOSURE

This disclosure relates generally to fluid dispensers and, more particularly, to fluid applicators for use with topical medications.

### BACKGROUND

A fluid dispenser generally includes a fluid container fluidly coupled to a pump. Typically, the pump includes an actuator. In cases where the fluid dispenser contains a topical medication (e.g., a medication to be applied to a person's skin), a person (e.g., a patient, a caregiver, a healthcare professional, etc.) may operate the actuator using their hand or hands to cause the pump to dispense a fluid containing the medication. The fluid dispensed from the pump may first be deposited onto a hand of the person and then applied by that person to a desired area of the body (e.g., the skin near a shoulder area, underarm, and/or other portion of the person) using that hand. Alternatively, the dispensed fluid containing the medication may be applied to an applicator pad or other application device such as a cap of the pump and this pad or other device may then be used to transfer the fluid to a desired area of the person's body.

### BRIEF DESCRIPTION OF THE DRAWINGS

FIG. 1 is a perspective view of an example fluid applicator assembly disclosed herein.

FIG. 2 is an exploded view of the example fluid applicator of FIG. 1.

FIG. 3 is an exploded view of the example fluid applicator assembly of FIG. 1 employing an alternative pump assembly disclosed herein.

FIG. 4 is a perspective view of an example fluid applicator assembly disclosed herein.

FIG. 5 is a perspective view of an example fluid applicator assembly disclosed herein.

FIGS. 6A-6B are exploded views of another example fluid applicator assembly disclosed herein.

FIG. 7 is a schematic of an example fluid applicator assembly having example actuator disclosure herein.

FIG. 8 a schematic of the example fluid applicator assembly of FIG. 7 having an alternative example actuator disclosure herein

FIG. 9 a schematic of the example fluid applicator assembly of FIG. 7 having another alternative example actuator disclosure herein

FIG. 10 a schematic of the example fluid applicator assembly of FIG. 7 having an alternative example actuator disclosure herein

FIG. 11a schematic of the example fluid applicator assembly of FIG. 7 having an alternative example actuator disclosure herein

FIG. 12 a schematic of the example fluid applicator assembly of FIG. 7 having an example pump assembly disclosed herein.

FIG. 13 a schematic of the example fluid applicator assembly of FIG. 7 including another example pump assembly disclosed herein.

FIG. 14 illustrates an example pump engine disclosed herein and employed in the example fluid applicator assembly of FIG. 6.

FIG. 15 illustrates the example fluid applicator assembly of FIG. 14 having an example transmission device disclosed herein.

FIGS. 16A-16D illustrate operation of the example fluid applicator assembly of FIG. 15.

FIGS. 17A-17B illustrate the example fluid applicator assembly of FIG. 14 having another example transmission device disclosed herein.

FIGS. 18A-18C illustrate the example fluid applicator assembly of FIG. 14 having another example transmission device disclosed herein.

FIGS. 19A-19B illustrate the example fluid applicator assembly of FIG. 14 having another example transmission device disclosed herein.

FIGS. 20A-20C illustrate the example fluid applicator assembly of FIG. 14 having another example transmission device disclosed herein.

FIGS. 21A-21H illustrate another example fluid applicator assembly disclosed herein.

FIG. 22 is a schematic of another example fluid applicator assembly disclosed herein.

FIG. 23 illustrates the example fluid applicator of assembly FIG. 22 having an example pump assembly disclosed herein.

FIG. 24 illustrates the example fluid applicator assembly of FIG. 22 having another example pump assembly disclosed herein.

FIG. 25 illustrates the example fluid applicator assembly of FIG. 22 employing an example actuator disclosed herein.

FIG. 26 illustrates the example fluid applicator assembly of FIG. 22 employing another example actuator disclosed herein.

FIG. 27 illustrates the example fluid applicator assembly of FIG. 22 employing another example actuator disclosed herein.

FIG. 28 illustrates the example fluid applicator assembly of FIG. 22 employing another example actuator disclosed herein.

FIG. 29 is a schematic of another example fluid applicator assembly disclosed herein.

FIG. 30 illustrates the example fluid applicator assembly of FIG. 29 employing an example actuator disclosed herein.

FIG. 31 is a schematic of another example fluid applicator assembly disclosed herein.

FIGS. 32A-32B are perspective views of another example fluid applicator assembly disclosed herein.

FIG. 33 illustrates the example fluid applicator assembly of FIGS. 32A-32B including an alternative actuator disclosed herein.

FIG. 34 illustrates the example fluid applicator assembly of FIGS. 32A-32B including another example actuator disclosed herein.

FIG. 35 illustrates the example fluid applicator assembly of FIGS. 32A-32B including another example actuator disclosed herein.

FIG. 36 illustrates the example fluid applicator assembly of FIGS. 32A-32B including another example actuator disclosed herein.

FIG. 37 illustrates the example fluid applicator assembly of FIGS. 32A-32B including another example actuator disclosed herein.

FIG. 38 illustrates the example fluid applicator assembly of FIGS. 32A-32B including another example actuator disclosed herein.

FIG. 39 illustrates the example fluid applicator assembly of FIGS. 32A-32B including an example pump assembly disclosed herein.

FIG. 40 illustrates the example fluid applicator assembly of FIGS. 32A-32B including an example pump assembly disclosed herein.

FIG. 41 illustrates the example fluid applicator assembly of FIGS. 32A-32B including an example pump assembly disclosed herein.

FIG. 42 is a cross-sectional view of another example fluid applicator assembly disclosed herein.

FIG. 43 is an exploded view of a portion of the example fluid applicator assembly of FIG. 42.

FIG. 44 is an exploded view of an example actuator of the example fluid applicator assembly of FIGS. 42-43.

FIG. 45 is a top view of an example counting mechanism employed by the example fluid applicator assembly of FIG. 42-44.

FIG. 46 is an exploded view of the example counting mechanism of FIG. 45.

FIG. 47 is an exploded view of the example counting mechanism of FIG. 46 including an aperture to receive a locking pin.

FIG. 48 is a cross-sectional view of a portion of the example fluid applicator assembly of 42 illustrating an example locking pin to engage the aperture of FIG. 46.

FIG. 49 is a cross-sectional view of another example fluid applicator assembly disclosed herein.

FIGS. 50A-50B illustrate an example valve disclosed herein.

FIGS. 51A-51B illustrate another example valve disclosed herein.

FIG. 52 illustrates an example valve disclosed herein.

FIGS. 53A-53B illustrate another example valve disclosed herein.

FIG. 54 illustrates an example valve disclosed herein.

FIG. 55A illustrates a perspective view of another example fluid applicator assembly disclosed herein.

FIG. 55B illustrates a perspective view of the example fluid applicator assembly of FIG. 55A depicting a cap and an applicator decoupled from a housing of the fluid applicator assembly.

FIG. 55C illustrates a perspective view of another example fluid applicator assembly disclosed herein.

FIG. 55D illustrates a perspective view of the example fluid applicator assembly of FIG. 55C illustrating a cap and an applicator decoupled from a housing of the fluid applicator assembly.

FIG. 56 is an exploded view of the example fluid actuator assembly of FIGS. 55A-55D.

FIG. 57 is an exploded view of the example fluid actuator assembly of FIGS. 55A-55D including an alternative fluid containment device disclosed herein.

FIG. 58 illustrates an example counting mechanism disclosed herein.

FIG. 59 illustrates another example counting mechanism disclosed herein.

FIG. 60 illustrates another example counting mechanism disclosed herein.

FIG. 61 illustrates an example cap disclosed herein.

FIG. 62 illustrates a plurality of example applicators disclosed herein.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used herein, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

FIG. 1 is a perspective view of an example fluid applicator system or assembly 100 disclosed herein. In the illustrated example, the fluid applicator assembly 100 includes a housing 102, an actuator 104 movably coupled to the housing 102, and a cap 106 removably coupled to the housing 102. The example cap 106 of FIG. 1 includes a base 108 to support the example fluid applicator assembly 100 on a surface (e.g., a countertop) when the cap 106 is coupled to the housing 102. In the illustrated example, a portion of the cap 106 is shown as being transparent to illustrate the relationship between various components disclosed herein. However, the cap 106 may be opaque. As illustrated in FIG. 1, an applicator 110 is visible through the transparent portion of the cap 106. When the example cap 106 of FIG. 1 is removed or separated from the example fluid applicator assembly 100, a dose (e.g., a given volume prescribed by a physician, a portion of the given volume prescribed by the physician, and/or any other amount) of a fluid (e.g., a liquid, foam, and/or gel such as, for example, a testosterone replacement therapy fluid and/or any other fluid containing a medication or treatment) may be dispensed onto the applicator 110. The example fluid applicator assembly 100 may then be used to apply the fluid to an application site (e.g., the skin) of a person or patient by contacting the applicator 110 to the application site, thereby transferring the fluid from the applicator 110 to the application site. In the illustrated example, the applicator 110 is fixedly coupled to an end 111 the housing 102 via an interference fit, a locking ridge or edge, etc.

In the illustrated example, the fluid is stored inside the fluid applicator assembly 100. In the illustrated example, the actuator 104 is an L-shaped button movable between a first position and a second position. In other examples, the actuator 104 is other shapes and/or located in other positions. When the example actuator 104 is moved from the first position to the second position, the example fluid applicator assembly 100 dispenses a dose of the fluid onto the applicator 110. In the illustrated example, the actuator 104 moves substantially linearly from the first position to the second position. More specifically, when the example actuator 104 moves from the first position to the second position, the example actuator 104 moves substantially perpendicularly to and toward a central, longitudinal axis 112 of the example housing 102. Other example actuators (FIGS. 7-10) used to implement the example fluid applicator assembly 100 move in other manners (e.g., rotatably (e.g., about the central, longitudinal axis 112 and/or other axes), substantially parallel to the central, longitudinal axis 112, away from the central, longitudinal axis 112, and/or in other manners). When the example actuator 104 is moved from the first position to the second position, the fluid applicator assembly 100 dispenses the fluid from inside the fluid applicator assembly 100 onto a surface or face 214 (FIG. 2) of the applicator 110. In some examples, the actuator 104 provides tactile and/or audible feedback (e.g., an audible clicking sound) when the example actuator 104 is moved to and/or in the second position (e.g., to indicate that the actuator 104 is in the second position). For example, when the actuator 104 reaches the second position, the actuator 104 engages or disengages a pawl and/or other device that produces a sound (e.g., the clicking sound) to indicate that the example actuator 104 is in and/or has reached the second position. In some examples, a force to move the actuator 104 from the first position to the second position is less than approximately seven pounds. In other examples, other forces move the actuator 104 from the first position to the second position.

The housing 102 and the actuator 104 in the illustrated example are sized and/or shaped to facilitate one-hand operation of the example fluid applicator assembly 100. For example, the example housing 102 is sized to substantially fit within a palm of a hand of the patient and shaped such that when the example housing 102 is held in the palm, an index finger of the hand of the patient substantially aligns with and follows a contour of the actuator 104 (e.g., the L-shape of the actuator 104 may substantially match a shape of the index finger bent at a knuckle). In other examples, the housing 102 and/or the actuator 104 are shaped and/or sized in other manners to, for example, align the actuator 104 with one or more additional and/or different fingers. In the illustrated example, when the actuator 104 is in the first position, a portion of an exterior surface 114 (FIG. 1) of the actuator 104 (e.g., a surface of the actuator 104 that may be contacted by the patient via the index finger to actuate the actuator 104) is substantially aligned (e.g., flush) with a portion of an exterior surface 116 of the housing 102. As a result, when the example actuator 104 is moved from the first position to the second position (e.g., toward the central, longitudinal axis 112), the example actuator 104 is depressed into the housing 102. Thus, the patient may hold the example fluid applicator assembly 100 in one hand and dispense the fluid onto the applicator 110 by squeezing the actuator 104 between the index finger and the palm of the hand. Without releasing the example fluid applicator assembly 100 from the hand, the patient may then apply the fluid to an application site by contacting the applicator 110 to the application site and transferring the fluid to the application site. In this manner, the patient may hold, handle and/or maneuver the example fluid applicator assembly 100, dispense a dose of the fluid onto the applicator 110, and administer the dose of the fluid via the applicator 110 to the application site using one hand and without contacting the fluid to either hand.

FIG. 2 is an exploded, perspective view of the example fluid applicator assembly 100 of FIG. 1. In the illustrated example, the fluid applicator assembly 100 includes a fluid containment system 200 to hold and/or store the fluid. In the illustrated example, the fluid containment system 200 includes a container 202 and a piston 203. In the illustrated example, the container 202 is substantially cylindrical and the piston 203, which is also cylindrical, is disposed inside and slidably coupled to the container 202. In other examples, the container 202 and/or the piston 203 are other shapes. In the illustrated example, the container 202 and the piston 203 define a chamber (e.g., an airtight or vacuum chamber) in which the fluid is held and/or stored. A cap or cover 204 is coupled to the container 202 to cover and/or seal the container 202. The example applicator assembly 100 of FIG. 2 includes a pump assembly 206 (e.g., an airless pump and/or any other type of pump) operatively coupled to the container 202 and the applicator 110. The example pump assembly 206 includes a pump engine 208 (e.g., a piston), a first one-way valve (i.e., a check valve) 210 and a spring 212. In the illustrated example, the pump assembly 206 is disposed between the container 202 and the applicator 110. The example pump assembly 206 is in fluid communication with the container 202 and the face 214 of the applicator 110 via the valve 210.

In the illustrated example, the pump assembly 206 pumps the fluid out of the container 202 and/or enables the fluid to flow out of the container 202 when a portion of the pump engine 208 is compressed and/or subjected to a sufficient compressive force. In the illustrated example, the container 202 is movably coupled to the housing 102. When the example actuator 104 moves from the first position to the second position, the actuator 104 drives the container 202 (e.g., via a cam, a ramp, a rack and pinion, and/or any other technique) toward the applicator 110 and compresses and/or applies a compressive force to the pump engine 208 (e.g., the container 202 compresses the pump engine 208 between the container 202 and the spring 212 and/or the applicator 110). As a result, the example first one-way valve 210 actuates (e.g., opens in response to an increase in the pressure of the fluid) and the pump engine 206 pumps a dose (e.g., a given amount) of the fluid and/or enables the dose of the fluid to flow from the container 202 onto the face 214 of the applicator 110 via an outlet 215 (e.g., one or more apertures defined by the applicator 110). In some examples, the example piston 203 moves with (e.g., follows) a level of the fluid in the container 202 (e.g., the piston 203 remains substantially in contact with the fluid as an amount of fluid held and/or stored in the container decreases). In the illustrated example, the container 202 is guided along the housing 102 by first rails, tracks, guides (e.g., guide channels) or ribs 216 of the housing 102 engaging second guides, rails or ribs 218 of the container 202.

In the illustrated example, when the fluid is pumped from the pump assembly 206 to the applicator 110, a pressure of the fluid actuates (e.g., opens) a second one-way valve 220 operatively coupled to the applicator 110. The example second one-way valve 220 substantially prevents air, liquids, debris (e.g., dirt), and/or other potential contaminants from entering a flow path of the fluid between the face 214 of the applicator 110 and the container 202 (e.g., the second one-way valve 220 substantially prevents air, liquid, debris and/or other potential contaminants from entering the fluid example applicator assembly 100). In some examples, the valve 220 also substantially prevents or reduces evaporation of the fluid stored inside the fluid applicator assembly 100. The example spring 212 biases the pump engine 208 and/or the container 202 away from the applicator 110. As a result, when the example actuator 104 is released, the spring 212 moves the container 202 away from the applicator 110, thereby returning the actuator 104 to the first, initial or storage position.

In some examples, the applicator 110 defines and/or includes a reservoir or second container upstream of the face 214 (e.g., between the applicator 110 and the pump engine 208) to receive and/or hold the fluid pumped from the container 202 when the actuator 104 is moved from the first position to the second position. In some examples, the reservoir or second container is separate from the applicator 110 and is disposed between the applicator 110 and the pump engine 208. In some examples, a portion of the applicator 110 is deformable (e.g., a portion of the applicator 110 may be elastically deformable) and deformation (e.g., by pressing the applicator 110 against an application site) of the portion of the applicator 110 urges the fluid from the second container onto the face 214 of the applicator 110. In some examples, a second actuator (e.g., a valve, a piston, a pump, and/or any other actuator) is operatively coupled to (e.g., in fluid communication with) the second container and actuation of the second actuator dispenses the fluid onto the face 214 of the applicator 110. In some examples, the face 214 is movable relative to the applicator 110. For example, if the face 214 of the applicator 110 is urged or pressed with sufficient force, the face 214 moves relative to a portion of the applicator 110 to release and/or pump the fluid from the second container onto the face 214 of the applicator 110 via the outlet 215. Thus, when the applicator 110 is pressed against the application site of the patient, the fluid is dispensed from the second container onto the face 214 of the applicator 110 and, thus, transferred to the application site.

FIG. 3 illustrates the example fluid applicator assembly 100 of FIGS. 1 and 2 having an alternative fluid containment system 300 disclosed herein. In the illustrated example, the fluid containment system 300 of FIG. 3 includes a support or casing 302, a container 304 (e.g., a pouch, a bag, etc.) and a tube (e.g., a dip tube) 306. In some examples, the container 304 is pliable or collapsable. In the illustrated example, the casing 302 holds and/or stores the fluid of the fluid applicator assembly 100. The example container 304 is disposed inside the example casing 302. In some examples, the container 304 is pliable (e.g., elastically deformable, non-elastically deformable, flexible, etc.) and may be at least partially made from and/or composed of plastic, fabric, metal foil and/or any other pliable material. In some examples, the container 304 substantially conforms to a shape of the casing 302. The example tube 306 of FIG. 3 is in fluid communication with the container 304 via an aperture 308 of the casing 302. In the illustrated example, the casing 302 is driven toward the applicator 110 and compresses the example pump engine 208, and the example pump engine 208 pumps and/or withdraws the fluid from the container 304 via the tube 306.

FIG. 4 is a perspective view of another example fluid applicator assembly 400 disclosed herein. In the illustrated example, the fluid applicator assembly 400 includes a housing 402 and a cap 404. The example cap 404 of FIG. 4 is shown as being transparent to illustrate the relationship between various components disclosed herein. However, the cap 404 may be opaque. In the illustrated example, an actuator 406 and an applicator 408 of the fluid applicator assembly 400 are visible through the cap 404. In the illustrated example, the applicator 408 is fixedly coupled to a first end 409 of the housing 402. The example cap 404 is removably coupled to the housing 402. When the example cap 404 is coupled to the housing 402, the cap 404 substantially surrounds and/or covers the applicator 408, the first end 409 of the housing 402 and the actuator 406. As a result, the example actuator 406 is substantially inaccessible and, thus, cannot be actuated when the example cap 404 is coupled to the housing 402. When the example cap 404 of FIG. 4 is removed or separated from the example fluid applicator assembly 400, a dose of a fluid (e.g., a liquid, foam, and/or gel such as, for example, a testosterone replacement therapy fluid and/or any other fluid) may be dispensed onto a surface or face 410 of the applicator 408 by actuating the actuator 406. The example fluid applicator assembly 400 may then be used to administer or apply the fluid to an application site (e.g., skin) of a patient by contacting the face 410 of the applicator 408 to the application site, thereby transferring the fluid from the face 410 of the applicator 408 to the application site.

In the illustrated example, the fluid is stored inside the fluid applicator assembly 400 (e.g., the fluid is stored in a container disposed inside the housing 402). In the illustrated example, the actuator 406 is a button disposed on a side 412 of the housing 402 (e.g., between the first end 409 and a second end 414 of the housing 402. The example housing 402 of FIG. 4 defines a recess 415 in which the example actuator 406 is disposed. In the illustrated example, the example fluid applicator assembly 400 of FIG. 4 may be supported (e.g., in a given orientation) on a surface via the second end 414 of the housing 402.

The example actuator 406 is movable between a first position (shown in FIG. 4) and a second position. When the example actuator 406 is moved from the first position the second position, the example fluid applicator assembly 400 dispenses a dose of the fluid onto the face 410 of the applicator 408. In the illustrated example, the actuator 406 moves substantially linearly from the first position to the second position. More specifically, when the example actuator 406 moves from the first position to the second position, the example actuator 406 moves substantially perpendicularly to and toward a central, longitudinal axis 416 of the example housing 402. Other example actuators move in other manners (e.g., rotatably, substantially parallel to the central, longitudinal axis 416, away from the central, longitudinal axis 416, and/or in other manners). As described in greater detail below, the actuator 406 may be operatively coupled to a pump assembly disposed inside the housing 402.

In some examples, the actuator 406 provides tactile and/or audible feedback (e.g., an audible clicking sound) when the example actuator 406 is moved to and/or in the second position (e.g., to indicate that the actuator 406 is in the second position). For example, when the actuator 406 reaches the second position, the actuator 406 engages or disengages a pawl and/or other device that produces a sound (e.g., the clicking sound) to indicate that the example actuator 406 is in and/or has reached the second position. In some examples, a force to move the actuator 406 from the first position to the second position is less than approximately seven pounds. In other examples, other forces move the actuator 406 from the first position to the second position.

The housing 402 and the actuator 406 in the illustrated example are sized and/or shaped to facilitate one-hand operation of the example fluid applicator assembly 400. For example, the housing 402 of the example fluid applicator assembly 400 of FIG. 4 is sized and shaped such that a patient may hold the fluid applicator assembly 400, actuate the actuator 406, and administer the dose of the fluid to the application site using one hand and without either hand contacting the fluid. In the illustrated example, the example housing 402 is elongated to facilitate the one-hand operation of the example fluid applicator assembly 400 of FIG. 4. For example, a height (e.g., a distance from the first end 409 to the second end 414) is greater than a length and width of the housing 402. Other examples are other shapes. The example actuator 406 is disposed along the side 412 of the housing 402 such that the patient may actuate (e.g., press) the actuator 406 with one or more fingers (e.g., a thumb) of a hand (e.g., when the cap 404 is removed) while holding the housing 402 in the same hand. In the illustrated example, the actuator 406 is spaced apart from the first end 409 of the housing 402 by a first distance less than a second distance from which the actuator 406 is spaced apart from the second end 414 of the housing 402. In other examples, the actuator 406 is disposed on other portions of the housing 402.

FIG. 5 is a perspective view of another example fluid applicator assembly 500 disclosed herein. In the illustrated example, the fluid applicator assembly 500 includes a housing 502, a cap 504 removably coupled to the housing 502, and an actuator 506 movably coupled to the housing 502. In the illustrated example, the cap 504 is shown as being transparent to illustrate the relationship between various components disclosed herein. However, the cap 504 may be opaque. As illustrated in FIG. 5, an applicator 508 of the fluid applicator assembly 500 is visible through the cap 504 in the perspective of FIG. 5. In the illustrated example, the applicator 508 is fixedly coupled to a first end 510 of the housing 502. When the example cap 504 is coupled to the housing 502, the cap 504 substantially surrounds and/or covers the applicator 508 and the first end 510 of the housing 502. A dose of a fluid (e.g., a liquid, foam, and/or gel such as, for example, a testosterone replacement therapy fluid and/or any other fluid) stored inside the example fluid applicator assembly 500 of FIG. 5 may be dispensed onto the applicator 508 by actuating the actuator 506. The example fluid applicator assembly 500 may then be used to administer or apply the fluid to an application site (e.g., skin) of a patient by contacting the applicator 508 to the application site, thereby transferring the fluid from the applicator 508 to the application site.

In the illustrated example, the actuator 506 is a button disposed on a side 512 of the housing 502 (e.g., between the first end 510 and a second end 514 of the housing 502. The example housing 502 of FIG. 5 defines a recess 516 in which the example actuator 506 is disposed. In the illustrated example, the example fluid applicator assembly 500 of FIG. 5 may be supported on a surface via the cap 504. In some examples, the cap 504 reduces, minimizes and/or prevents evaporation of the fluid or a constituent (e.g., alcohol, water, etc.) of the fluid inside the example fluid applicator assembly 100 of FIG. 5.

The example actuator 506 is movable between a first position (shown in FIG. 5) and a second position when the example cap 504 is decoupled from the example fluid applicator assembly 500 of FIG. 5. In some examples, the cap 504 engages the actuator 506 (e.g., via one or more teeth) when the cap 504 is coupled to the housing 502 to prevent movement of the actuator 506. When the example cap 504 is decoupled from the housing 502, the cap 504 disengages the actuator 506, and the actuator 506 is free to move from the first position to the second position. When the example actuator 506 moves from the first position to the second position, the example fluid applicator assembly 500 dispenses a dose of the fluid onto the applicator 508 to enable the fluid to be administered to the application site by contacting the applicator 508 to the application site. In the illustrated example, the actuator 506 moves substantially linearly from the first position to the second position. More specifically, when the example actuator 506 moves from the first position to the second position, the example actuator 506 moves substantially perpendicularly to and toward a central, longitudinal axis 518 of the example housing 502. Other example actuators move in other manners (e.g., rotatably, substantially parallel to the central, longitudinal axis 518, away from the central, longitudinal axis 518, and/or in other manners). As described in greater detail below, the actuator 506 may be operatively coupled to a pump assembly disposed inside the housing 502.

In some examples, the actuator 506 provides tactile and/or audible feedback (e.g., an audible clicking sound) when the example actuator 506 is moved to and/or in the second position (e.g., to indicate that the actuator 506 is in the second position). For example, when the actuator 506 reaches the second position, the actuator 506 engages or disengages a pawl and/or other device that produces a sound (e.g., the clicking sound) to indicate that the example actuator 506 is in and/or has reached the second position. In some examples, a force to move the actuator 506 from the first position to the second position is less than approximately seven pounds. In other examples, other forces move the actuator 506 from the first position to the second position.

The housing 502 and the actuator 506 in the illustrated example are sized and/or shaped to facilitate one-hand operation of the example fluid applicator assembly 500. For example, the housing 502 of the example fluid applicator assembly 500 of FIG. 5 is sized and shaped such that a patient may hold the fluid applicator assembly 500, actuate the actuator 506, and administer the dose of the fluid to the application site using one hand without contacting either hand to the fluid. In the illustrated example, the example housing 502 is elongated to facilitate the one-hand operation of the example fluid applicator assembly 500 of FIG. 5. For example, a height (e.g., a distance from the first end 510 to the second end 514) is greater than a length and width of the housing 502. Other examples are other shapes. The example actuator 506 is disposed along the side 512 of the housing 502 such that the patient may actuate (e.g., press) the actuator 506 with one or more fingers (e.g., a thumb) of a hand while holding the housing 502 in the same hand. In the illustrated example, the actuator 506 is adjacent the first end 510 of the housing 502 to facilitate the one-hand operation. In other examples, the actuator 506 is disposed in other positions.

FIG. 6A is a partially exploded, perspective view of another example fluid applicator assembly 600 disclosed herein. In the illustrated example, the fluid applicator assembly 600 includes a housing 602, a cap 604, an actuator 606 and an applicator 608. In the illustrated example, the applicator 608 is fixedly coupled to a first end 609 of the housing 602. The example cap 604 is removably couplable to the housing 602. When the example cap 604 is coupled to the housing 602, the cap 604 substantially surrounds and/or covers the applicator 608, the first end 609 of the housing 602 and the actuator 606. As a result, the example actuator 606 is substantially inaccessible when the example cap 604 is coupled to the housing 602. When the example cap 604 of FIG. 6A is removed or separated from the example fluid applicator assembly 600, a dose of a fluid (e.g., a liquid, foam, and/or gel such as, for example, a Testosterone Replacement Therapy fluid and/or any other fluid) may be dispensed onto a surface or face 610 of the applicator 608 by actuating the actuator 606. The example fluid applicator assembly 600 may then be used to administer or apply the fluid to an application site (e.g., skin) of a patient by contacting the face 610 of the applicator 608 to the application site, thereby transferring the fluid from the face 610 of the applicator 608 to the application site.

In the illustrated example, the fluid is stored inside the fluid applicator assembly 600. In the illustrated example, the actuator 606 is a button disposed on a side 612 of the housing 602 (e.g., between the first end 609 and a second end 614 of the housing 602. The example actuator 606 is movable between a first position (shown in FIG. 6A) and a second position. When the example actuator 606 of FIG. 6A is in the first position, the example actuator 606 extends from housing away from a central, longitudinal axis 616 of the housing 602. When the example actuator 606 is moved from the first position the second position, the example fluid applicator assembly 600 dispenses a dose of the fluid onto the face 610 of the applicator 608 via an outlet 615 defined by applicator 608. In the illustrated example, the actuator 606 moves substantially linearly from the first position to the second position. More specifically, when the example actuator 606 moves from the first position to the second position, the example actuator 606 moves substantially perpendicularly to and toward the central, longitudinal axis 616 of the example housing 602. Other example actuators move in other manners (e.g., rotatably, substantially parallel to the central, longitudinal axis 616, away from the central, longitudinal axis 616, and/or in other manners).

In some examples, the actuator 606 provides tactile and/or audible feedback (e.g., an audible clicking sound) when the example actuator 606 is moved to and/or in the second position (e.g., to indicate that the actuator 506 is in the second position). For example, when the actuator 606 reaches the second position, the actuator 606 engages or disengages a pawl and/or other device that produces a sound (e.g., the clicking sound) to indicate that the example actuator 606 is in and/or has reached the second position. In some examples, a force to move the actuator 606 from the first position to the second position is less than approximately seven pounds. In other examples, other forces move the actuator 606 from the first position to the second position.

The housing 602 and the actuator 606 in the illustrated example are sized and/or shaped to facilitate one-hand operation of the example fluid applicator assembly 600. For example, the housing 602 of the example fluid applicator assembly 600 of FIG. 6A is sized and shaped such that a patient may hold the fluid applicator assembly 600, actuate the actuator 606, and administer the dose of the fluid to the application site using one hand. In the illustrated example, the example housing 602 is elongated to facilitate the one-hand operation of the example fluid applicator assembly 600 of FIG. 6A. For example, a height (e.g., a distance from the first end 609 to the second end 614) is greater than a length and width of the housing 602. Other examples are other shapes. The example actuator 606 is disposed along the side 612 of the housing 602 such that the patient may actuate (e.g., press) the actuator 606 with one or more fingers (e.g., a thumb) of a hand (e.g., when the cap 604 is removed) while holding the housing 602 in the same hand. In the illustrated example, the actuator 606 is spaced apart from the first end 609 of the housing 602 by a first distance, which is less than a second distance by which the actuator 606 is spaced apart from the second end 614 of the housing 602. In other examples, the actuator 606 is disposed in other positions.

FIG. 6B is a partially exploded, perspective view of the example fluid applicator assembly 600 of FIG. 6A. In the illustrated example, a fluid containment system 618 (e.g., a pouch) is disposed inside and coupled to the example housing 602. The example fluid containment system 618 holds one or more doses of the fluid. In some examples, the fluid containment system 618 is fixedly coupled to the housing 602. In other examples, the fluid containment system 618 is removably coupled to the housing 602.

In the illustrated example, the fluid applicator assembly 600 includes a pump assembly 620 operatively coupled to the actuator 606. The example pump assembly 620 is fluidly coupled to the fluid containment system 618 and the outlet 615. The example pump assembly 620 may pump the fluid from the fluid containment system 618 onto the face 610 of the applicator 608 via the outlet 615. In the illustrated example, when the actuator 606 is moved from the first position to the second position, the actuator 606 actuates the pump assembly 620 to cause the pump assembly 620 to pump the fluid and/or allow the fluid to flow from the fluid containment system 618 onto the face 610 of the applicator 608.

FIGS. 7-10 are side, schematic views of an example fluid applicator assembly 700 disclosed herein implemented using a variety of actuators 702, 800, 900, 1000 disclosed herein. In some examples, one or more of the actuators 702, 800, 900, 1000 of FIGS. 7-10 are used to implement the example fluid applicator assembly 100 of FIGS. 1-2, the example fluid applicator assembly 100 of FIG. 3, the example fluid applicator assembly 400 of FIG. 4, the example fluid applicator assembly 500 of FIG. 5, the example fluid applicator assembly 600 of FIGS. 6A-6B and/or any other example fluid applicator assembly.

Referring to FIG. 7, the example fluid actuator assembly 700 includes an applicator 704 coupled to a housing 706. A fluid containment system 708 (e.g., a casing and a pouch) is disposed inside the example housing 706. In the illustrated example, a pump assembly 710 is disposed inside the housing 706 between the fluid containment system 708 and the applicator 704. The example pump assembly 710 is fluidly coupled to the fluid containment system 708 and the applicator 704 to pump a fluid 712 stored in the fluid containment system 708 onto a face or surface 716 of the applicator 704. The pump assembly 710 may be any type of pump and may include a linear pump engine (e.g., a pump engine that actuates and pumps fluid in substantially the same direction), a ninety-degree pump engine (e.g., a pump engine that is actuated in first direction and pumps the fluid 712 in a second direction substantially perpendicular to the first direction), an airless pump system, and/or any other pump assembly component(s).

The example actuator 702 of FIG. 7 is a trigger operatively coupled to the pump assembly 710 of FIG. 7. When the example actuator 702 is actuated from a first position to a second position, the actuator 702 operates the pump assembly 710, and the pump assembly 710 pumps a dose of the fluid 712 onto the surface 716 of the applicator 704. In the illustrated example, the actuator 702 is substantially wedge-shaped. Other examples have other shapes, sizes, orientations and/or configurations.

In some examples, the actuator 702 of FIG. 7 is actuated by squeezing the example actuator 702 toward the pump assembly 710 (e.g., between a palm of a hand and fingers of the hand). In some examples, the actuator 702 of FIG. 7 is pivotably coupled to the housing 706 and rotates about a pivot adjacent the applicator 704. In some examples, the actuator 702 is pivotably coupled to the housing 706 via a pivot adjacent a first end 714 of the housing 706 opposite the applicator 704 and/or any other position. Thus, in some examples, the actuator 702 functions as a lever. In some examples, the actuator 702 moves linearly (e.g., translates or slides) toward the pump assembly 710 to operate the example pump assembly 710.

FIG. 8 illustrates another example actuator 800 disclosed herein. The example actuator 800 of FIG. 8 may be used as an alternative to or in addition to the example actuator 702 of FIG. 7. In the illustrated example, the actuator 800 is a lever rotatably coupled to the housing 706 (e.g., via a pivot). The example actuator 800 has a distal end 802 that is spaced apart from the housing 706. Other examples have other shapes, sizes, orientations, and/or configurations. In the illustrated example, the actuator 800 is operatively coupled to the pump assembly 710 and moves from a first position to a second position to operate the pump assembly 710. In the illustrated example, when the actuator 800 is moved (e.g., rotated or pivoted) from the first position to the second position, the distal end 802 of the example actuator 800 moves away from the housing 706. Thus, in the illustrated example, the actuator 800 rotates clockwise in the orientation of FIG. 8. In some examples, the actuator 800 is slidably coupled to the housing 706, and the actuator 800 translates or slides away from the housing 706 (e.g., to the left in the orientation of FIG. 8) to operate the example pump assembly 710. Thus, a patient may dispense a dose of the fluid 712 by pulling the example actuator 800 away from the housing 706.

FIG. 9 illustrates the example fluid applicator assembly 700 of FIGS. 7-8 implemented using another example actuator 900 disclosed herein. In the illustrated example, the actuator 900 is a button slidably coupled to the example housing 706. To actuate the actuator 900 and, thus, operate the pump assembly 710, the actuator 900 moves from a first position to a second position toward the pump assembly 710. In the illustrated example, the actuator 900 may be pressed or depressed toward the pump assembly 710 to actuate the example actuator 900. In the illustrated example, the actuator 900 has an elongated shape and is oriented such that a longitudinal axis of the actuator 900 is substantially parallel to a longitudinal axis 902 of the fluid applicator assembly 700. In some examples, the actuator 900 is oriented such that the longitudinal axis of the actuator 900 is angled away from the longitudinal axis of the example fluid applicator assembly 700. Other examples have other shapes, sizes, orientations and/or configurations.

FIG. 10 illustrates the example fluid applicator assembly 700 of FIGS. 7-9 implemented using another example actuator 1000 disclosed herein. In the illustrated example, the actuator 1000 is a button slidably coupled to the example housing 706. To actuate the actuator 1000 and, thus, operate the pump assembly 710, the actuator 1000 moves from a first position to a second position toward the pump assembly 710. In the illustrated example, the actuator 1000 may be pressed or depressed toward the pump assembly 710 to actuate the example actuator 1000. In the illustrated example, the actuator 1000 has an elongated shape and is oriented such that a longitudinal axis of the actuator 1000 is substantially perpendicular to the longitudinal axis 902 of the fluid applicator assembly 700. In some examples, the actuator 1000 is oriented such that the longitudinal axis of the actuator 1000 is oriented at other angles relative to the longitudinal axis 902 of the fluid applicator assembly 700 (e.g., 30 degrees, 45 degrees, etc.). Some examples have other shapes, sizes, orientations and/or configurations.

FIGS. 11-13 are side, schematic views of the example fluid applicator assembly 700 of FIGS. 7-10 implementing using a variety of transmission devices to actuate the pump assembly 710. The example pump assembly 710 of FIG. 11 includes a piston 1100 disposed in a chamber 1102 of the fluid containment system 708. In the illustrated example, the fluid applicator assembly 700 includes a transmission device 1104 operatively coupled to the piston 1100 and an actuator 1106. The example actuator 1106 may be implementing using the actuator 702 of FIG. 7, the actuator 800 of FIG. 8, the actuator 900 of FIG. 9, the actuator 1000 of FIG. 10, and/or any other example actuator.

In the illustrated example, the transmission device 1104 of FIG. 11 includes a ratchet 1108 coupled to a shaft 1110. The example piston 1100 is rotatably coupled to the shaft 1110 via a lead screw 1112 and slidably coupled to the fluid containment system 708. When the example actuator 1106 moves from a first position to a second position (e.g., toward the shaft 1110), the ratchet 1108 moves with the actuator 1106 to rotate the shaft 1110 and, thus, moves the piston 1100 toward the applicator 704 along the shaft 1110 via the threads of the lead screw 1112. As the piston 1100 moves toward the applicator 704, the piston moves (e.g., pushes the fluid 712, withdraws from the fluid containment system 708 via vacuum forces, etc.) the fluid 712 out of the fluid containment system 708 and onto the example face 716 of the applicator 704. When the example actuator 1106 moves from the second position to the first position, the ratchet 1108 does not rotate the shaft 1110 toward or away from the applicator 704.

FIG. 12 illustrates the example fluid applicator assembly 700 having another example transmission device 1200 disclosed herein. In the illustrated example, the pump assembly 710 includes a ninety-degree pump 1202. In the illustrated example, the ninety-degree pump 1202 is operated by actuating a piston 1204 in a direction substantially perpendicular to the longitudinal axis 902 of the housing 706 and, thus, a flow of the fluid 712 from the fluid containment system 708 to the applicator 704. In the illustrated example, an actuator 1206 (e.g., the actuator 702 of FIG. 7, the actuator 800 of FIG. 8, the actuator 900 of FIG. 9, the actuator 1000 of FIG. 10, and/or any other example actuator) is coupled to the piston 1204 via the transmission device 1200. In some examples, the piston 1204 and one or more components of the transmission device 1200 and/or the actuator 1206 are integral. In some examples, the actuator 1206 is directly coupled to the piston 1204.

In the illustrated example, the transmission device 1200 includes is a stem 1208 that moves with the example actuator 1206 and the piston 1204. In some examples, the actuator 1206 is non-rotatably coupled to the stem 1208 to enable the actuator 1206 and the stem 1208 to move linearly (e.g., translate) to actuate the piston 1204. In some examples, the stem 1208 is rotatably coupled to the actuator 1206 to enable rotation of the actuator 1206 to move the stem 1208 linearly to actuate the example piston 1204.

FIG. 13 illustrates the example fluid applicator assembly 700 employing another example transmission device 1300. In the illustrated example, the transmission device 1300 includes a first ramp 1302 and a second ramp 1304. The example first ramp 1302 is coupled to an actuator 1306 (e.g., the actuator 702 of FIG. 7, the actuator 800 of FIG. 8, the actuator 900 of FIG. 9, the actuator 1000 of FIG. 10, and/or any other example actuator), and the example second ramp 1304 is coupled to the pump assembly 710. In the illustrated example, the pump assembly 710 includes a linear pump engine 1308 (e.g., the pump assembly 710 is actuated in a direction substantially parallel to a direction in which the pump assembly 710 pumps the fluid 712). In the illustrated example, the first ramp 1302 and the second ramp 1304 are wedge-shaped. In other examples, the first ramp 1302 and/or the second ramp 1304 are other shapes. For example, the first ramp 1302 or the second ramp 1304 may be rounded or curved (e.g., pin-shaped).

The example fluid containment system 708 of FIG. 13 is movably coupled to the housing 706. A first portion of the linear pump engine 1308 is fixedly coupled to the fluid containment system 708 to move with the fluid containment system 708. A second portion of the linear pump engine 1308 is fixedly coupled to the housing 706 and movably coupled to the first portion of the linear pump engine 1308. When the first portion of the example pump engine 1308 moves relative to the second portion of the example pump engine 1308, the pump assembly 710 pumps the fluid 712 from the fluid containment system 708 onto the face 716 of the applicator 704. When the example actuator 1306 is actuated (e.g., moved toward the pump assembly 710), the first ramp 1302 engages the second ramp 1304 to urge the first portion of the pump engine 1308 and, thus, the fluid containment system 708 toward the applicator 704. As a result, the first portion of the pump engine 1308 moves relative to the second portion of the pump engine 1308 and the pump assembly 710 pumps the fluid 712 from the fluid containment system 708 onto the face 716 of the applicator.

In the illustrated example, the first ramp 1302 and the second ramp 1304 are oriented such that linear movement of the example actuator 1306 in a first direction (e.g., to the left in the orientation of FIG. 13) moves the first portion of the pump engine 1308 and the fluid containment system 708 in a second direction substantially perpendicular to the first direction. More specifically, the example first ramp 1302 and the example second ramp 1304 are oriented such that movement of the actuator 1306 urges the first portion of the pump engine 1308 toward the applicator 704. In other examples, the orientation of the first ramp 1302 and the second ramp 1304 are substantially reversed such that movement of the actuator 1306 moves the first portion of the pump engine 1308 away from the applicator 704.

FIG. 14 illustrates an example pump assembly 1400 disclosed herein. In the following examples, the pump assembly 1400 is shown in conjunction with the fluid applicator assembly 600 of FIGS. 6A-6B. In some examples, the example pump assembly 1400 is employed by the example fluid applicator assembly 100 of FIGS. 1-3, the example fluid applicator assembly 400 of FIG. 4, the example fluid applicator assembly 500 of FIG. 5, and/or is used to implement the example fluid pump assembly 710 of the example fluid applicator assembly 700 of FIGS. 7-13. In other examples, the example fluid applicator assembly 100 of FIGS. 1-2, the example fluid applicator 100 of FIG. 3, the example fluid applicator assembly 400 of FIG. 4, the example fluid applicator assembly 500 of FIG. 5, the example fluid applicator assembly 600 of FIGS. 6-7 and/or the example fluid applicator assembly 700 of FIGS. 7-13 employ other pump assemblies.

The example pump assembly 1400 of FIG. 14 includes a pump engine 1402 such as, for example, one of the pump engines described in U.S. Pat. No. 7,481,336, entitled “Manually-Actuated Metering Pump,” which was filed on Jun. 13, 2005 and is hereby incorporated herein by reference in its entirety. The example pump engine 1402 of FIG. 14 includes a first portion 1404 and a second portion 1406. In the illustrated example, the second portion 1406 is fixedly coupled to the housing 602. The example second portion 1406 is fluidly coupled to the fluid containment system 708 via a first fluid interface 1408 (e.g., an inlet, a tube, a fitting, and/or any other fluid interface).

The first portion 1404 of the example pump engine 1402 is movably coupled to the second portion 1406. In some examples, the first portion 1404 is a piston. The example first portion 1404 is fluidly coupled to the second portion 1406 and the outlet 615 of the applicator 608 via a second fluid interface 1410 (e.g., an outlet, a tube, a spout, and/or any other fluid interface). In some examples, the first portion 1404 is biased toward a first position (e.g., an unactuated position) relative to the second portion 1406 of the example pump engine 1402. For example, a spring (not shown) may be seated between the first portion 1404 and the second portion 1406. In some examples, the first portion 1404 is moveable relative to the second portion 1406 via, for example, one or more compressible components such as bellows.

The example pump assembly 1400 of FIG. 14 also includes a plunger or piston 1412. In the illustrated example, the piston 1412 is movably coupled to the housing 602 and the pump engine 1402. The example piston 1412 of FIG. 14 substantially surrounds the first portion 1404 of the pump engine 1402. In the illustrated example, the piston 1412 includes a tube 1414 in which a portion of the second fluid interface 1410 is received. In the illustrated example, second fluid interface 1410 is fluidly coupled to the outlet 615 via the tube 1414. For example, the tube 1414 directs fluid pumped by the pump engine 1402 from the second fluid interface 1410 to the outlet 615. In the illustrated example, the pump assembly 1400 includes a spring 1416 to urge the piston 1412 toward an unactuated position. In the illustrated example, the spring 1416 is a helical spring seated between the piston 1412 and the housing 602. In some examples, the actuator 606 is operatively coupled to the piston 1412 via a transmission device such as, for example, the example transmission device 1104 of FIG. 11, the example transmission device 1200 of FIG. 12, the example transmission device 1300 of FIG. 13 and/or any other transmission device.

In the illustrated example, the pump assembly 1400 includes a one-way valve 1418 operatively coupled to tube 1414 of the example piston 1412. The example one-way valve 1418 substantially prevents air, liquid, debris and/or other fluids and/or materials from entering the example fluid applicator assembly 600 via the outlet 615. In some examples, the valve 1418 reduces and/or substantially prevents evaporation of the fluid stored in the example fluid containment system 618. The example one-way valve 1418 may be implemented using a linear valve (e.g., ball valve, a poppet, an umbrella valve, a plug or stopper, etc.), a rotary valve (e.g., a butterfly valve), a duckbill valve, an inward-collapsing cone, a cantilevered finger, a deformable cage, a flapper valve, a permeable membrane and/or any other one-way valve. In the illustrated example, the one-way valve 1418 is fixedly coupled to the tube 1414 such that when the example piston 1412 is in the unactuated position (shown in FIG. 14), the one-way valve 1418 substantially obstructs, plugs and/or seals the outlet 615. When the example piston 1412 moves to an actuated position via the actuator 606, the example one-way valve 1418 moves with the piston 1412 such that the one-way valve 1418 does not obstruct, plug and/or seal the outlet 615, thereby enabling fluid to flow past the one-way valve 1418 and onto the face 610 of the applicator 608.

FIG. 15 is a perspective, cutaway view of the example fluid applicator assembly 600 of FIG. 14 employing an example transmission device 1500 disclosed herein to operate the example pump assembly 1400 of FIG. 14 via the actuator 606. In the illustrated example, the transmission device 1500 includes two cam assemblies 1502, 1504. The example cam assembly 1502 is substantially identical to the example cam assembly 1504 and, thus, the following description of the cam assembly 1502 can be applied to the cam assembly 1504. Therefore, to avoid redundancy, the cam assembly 1504 is not separately described herein.

The example cam assembly 1502 includes a first arm 1506 and a cam 1508. In the illustrated example, the first arm 1506 is fixedly coupled to the cam 1508 and rotatably coupled to the housing 602 via a fulcrum 1510. Thus, the example cam 1508 is rotatably coupled to the housing 602 via the first arm 1506. A distal end 1512 of the example first arm 1506 engages a second arm 1514. In the illustrated example, the actuator 606 is substantially L-shaped and defines the second arm 1514. In other examples, the actuator 606 is other shapes (e.g., wedge-shaped, rectangular, etc.) and the second arm 1514 is coupled to the actuator 606. In the illustrated example, the piston 1412 includes protrusions or wings 1516, 1518. As described in conjunction with FIGS. 16A-D below, when the example actuator 606 is actuated from the first position to the second position, the cam 1508 rotates and engages the wing 1516 to actuate the piston 1412 to operate the example pump assembly 1400.

FIGS. 16A-16D are side, cutaway views of the example fluid applicator assembly 600 of FIGS. 14-15 as the actuator 606 is moved from the first position (FIG. 16A) to the second position (FIG. 16D). Referring to FIG. 16A, in the illustrated example, the actuator 606 and the pump assembly 1400 are in the first position (e.g., an unactuated position). As a result, the spring 1416 (FIGS. 14-15) is at least partially extended and is supporting the example piston 1412 such that the one-way valve 1418 (FIG. 14) is substantially obstructing and/or sealing the outlet 615. When the example piston 1412 is in the first position, the cam 1508 is extends from the first arm 1506 and away from the actuator 606 (e.g., the cam 1508 is substantially horizontal in the orientation of FIG. 16A). In the illustrated example, the second arm 1514 includes a slot 1600 to receive the distal end 1512 of the first arm 1506.

Referring to FIGS. 16B and 16C, as the example actuator is actuated (e.g., linearly moved toward the pump assembly 1400 or to the right in the orientation of FIGS. 16B and 16C), the second arm 1514 moves substantially linearly to the right in the orientation of FIGS. 16B-16C (e.g., perpendicular to the longitudinal axis 616 of the housing 602). As a result, the second arm 1514 rotates the first arm 1506 (e.g., clockwise in the orientation of FIGS. 16B-C) and the example cam 1508 engages the wing 1516 and moves the piston 1412 away from the applicator 608. When the example piston 1412 moves away from the applicator 608, the piston 1412 moves the first portion 1404 of the pump engine 1402 relative to the second portion 1406 of the pump engine 1402 (e.g., the pump engine 1402 compresses between the piston 1412 and the housing 602 and/or the fluid containment system 622) and pumps fluid 1602 stored in the fluid containment system 622 onto the face 610 of the applicator 608.

In FIG. 16B, a first amount (e.g., volume) of the fluid 1602 is dispensed onto the face 610 of the example applicator 608. As the actuator 606 is further actuated from a first partially or semi-actuated position shown in FIG. 16B to a second semi-actuated position shown in FIG. 16C, the pump assembly 1400 further pumps the fluid 1602 onto the face 610 of the applicator 608. Thus, in FIG. 16C, a second amount of fluid greater than the first amount is disposed on the example face 610.

In FIG. 16D, the example actuator 606 is in the second or fully actuated position. In some examples, the actuator 606 is prevented from actuating past (e.g., moving farther to the right in the orientation of FIG. 16D) the fully actuated position via, for example, a stop or obstruction. In some examples, the actuator 606 contacts the stop to substantially prevent further actuation of the actuator 606. In other examples, the piston 1412 and/or the first portion 1404 of the pump engine 1402 contacts the stop to substantially prevent further actuation of the actuator 606. In some examples, when the actuator 606 reaches the fully actuated position, the actuator 606 engages or disengages a pawl and/or other device that produces a sound (e.g., a clicking sound) to indicate that the example actuator 606 is in and/or has reached the fully actuated position. Once the example actuator 606 is in the fully actuated position as shown in FIG. 16D, a third amount of the fluid 1602 corresponding to a dose is dispensed onto the face 610 of the example applicator 608. A patient may then administer the dose of the fluid 1602 to an application site by contacting the face 610 of the example applicator 608 to the application site.

FIGS. 17A-B are side, cutaway views illustrating the example fluid applicator assembly 600 employing another example transmission device 1700 disclosed herein to operate the example pump assembly 1400 of FIG. 14 via the actuator 606. In the illustrated example, the transmission device 1700 includes a first ramp 1702 and a second ramp 1704. In the illustrated example, the first ramp 1702 and the actuator 606 are integral. In other examples, the first ramp 1702 is coupled to the actuator 606. The example second ramp 1704 extends from a side 1706 of the piston 1412 (e.g., perpendicularly to the longitudinal axis 616 of the housing 602). In the illustrated example, the first ramp 1702 is disposed closer to the applicator 608 than the second ramp 1704 (e.g., the first ramp 1702 is disposed above the second ramp 1704 in the orientation of FIGS. 17A and 17B).

The example first ramp 1702 has a first ramped surface 1708 (e.g., a surface angled and/or curved away from (e.g., nonparallel to) a direction of movement of the actuator 606) to engage a second ramped surface 1710 of the second ramp 1704 (e.g., a surface angled and/or curved away from (e.g., nonparallel to) a direction of movement of the piston 1412). In the illustrated example, the first ramped surface 1708 of the first ramp 1702 faces partially away from the example applicator 608, and the second ramped surface 1710 of the second ramp 1704 faces partially toward the example applicator 608. As a result, when the example actuator 606 is moved from a first, unactuated position shown in FIG. 17A to a second, fully actuated position shown in FIG. 17B, the first ramped surface 1708 of example first ramp 1702 engages the second ramped surface 1710 of the example second ramp 1704 and moves the piston 1412 away from the applicator 608 (e.g., downward in the orientation of FIGS. 17A-B), thereby operating the pump assembly 1400 and dispensing a dose of the fluid 1612 onto the face 610 of the applicator 608.

FIGS. 18A-18C are side, cutaway views illustrating the example fluid applicator assembly 600 employing another example transmission device 1800 disclosed herein to operate the example pump assembly 1400 of FIG. 14 via the actuator 606. Referring to FIG. 18A, in the illustrated example, the transmission device 1800 includes the first ramp 1802 and a second ramp 1804. In the illustrated example, the first ramp 1802 and the actuator 606 are integral. In other examples, the first ramp 1802 is coupled to the actuator 606. The example second ramp 1804 extends from a side 1806 of the piston 1412 (e.g., perpendicularly to the longitudinal axis 616 of the housing 602).

The example first ramp 1802 has a first ramped surface 1808 (e.g., a surface angled and/or curved away from (e.g., nonparallel to) a direction of movement of the actuator 606) to engage a second ramped surface 1810 of the second ramp 1804 (e.g., a surface angled and/or curved away from (e.g., nonparallel to) a direction of movement of the piston 1412). In the illustrated example, the first ramped surface 1808 of the first ramp 1802 faces partially toward the example applicator 608, and the second ramped surface 1810 of the second ramp 1804 faces partially away the example applicator 608. As a result, when the example actuator 606 is moved from a first, unactuated position shown in FIG. 18A to a second, fully actuated position shown in FIG. 18C, the first ramped surface 1808 of example first ramp 1802 engages the second ramped surface 1810 of the example second ramp 1804 and moves the piston 1412 toward the applicator 608 (e.g., upward in the orientation of FIGS. 18A-B), thereby operating the pump assembly 1400 and dispensing a dose of the fluid 1612 onto the face 610 of the applicator 608.

Referring to FIG. 18B, to enable the example pump assembly 1400 of FIGS. 18A-18B to be operated when the example piston 1412 is moved upward in the orientation of FIGS. 18A-18C, the second portion 1406 of the example pump engine 1402 is fixedly coupled to the piston 1412. The first portion 1404 of the example pump engine 1402 seated against the applicator 608 and movably coupled to the piston 1412. The second portion 1406 of the example pump engine 1402 is fixedly coupled to the fluid containment system 622, and the example fluid containment system 622 of FIGS. 18A-18C is movably coupled to the example housing 602. In the illustrated example, the spring 1416 is seated between the applicator 608 and the piston 1412 to bias or urge the piston 1412 away from the applicator 608. As a result, when the example piston 1412 moves toward the applicator 608, the piston 1412 moves the second portion 1406 of the example pump engine 1402 toward the applicator 608 and relative to the first portion 1404, thereby operating the example pump assembly 1400 and dispensing the fluid onto the face 610 of the applicator 608.

FIG. 18C illustrates the example fluid applicator assembly 600 of FIGS. 18A-B when the actuator 606 is in the fully actuated position. In the illustrated example, the piston 1412 and, thus, the fluid containment system 622 are moved (e.g., lifted) toward the applicator 608 from the unactuated position such that the spring 1416 is at least partially compressed. When the example actuator 606 is released, the example spring 1416 urges the piston 1412 away from the applicator 608 to enable the pump assembly 1400 to be subsequently operated.

FIGS. 19A-B are side, cutaway views illustrating the example fluid applicator assembly 600 employing another example transmission device 1900 disclosed herein to operate the example pump assembly 1400 of FIG. 14 via the actuator 606. In the illustrated example, the transmission device 1900 includes a first rack 1902, a second rack 1904 and a pinion 1906. In the illustrated example, the first rack 1902 extends from the actuator 606 into the housing 602 (e.g., substantially perpendicular to the longitudinal axis 616 of the housing 602). The example second rack 1904 is coupled to the piston 1412 and is oriented substantially perpendicular to the first rack 1902 (e.g., the second rack 1904 is substantially parallel to the longitudinal axis 616). The example pinion 1906 is rotatably coupled to the housing 602 and operatively coupled to the first rack 1902 and the second rack 1904.

When the example actuator 606 is moved from the unactuated position to the fully actuated position, the example fluid applicator assembly 600 of FIGS. 19A-19B dispenses a dose of the fluid onto the face 610 of the applicator 608. In the illustrated example, when the actuator 606 moves toward the fully actuated position, the first rack 1902 moves linearly and rotates the pinion 1906 (e.g., counterclockwise in the orientation of FIGS. 19A-19B). As a result, the pinion 1906 drives the second rack 1904 and, thus, the piston 1412 away from the applicator 608, thereby operating the example pump assembly 1400 to dispense the fluid onto the face 610 of the applicator 608.

FIGS. 20A-20C are side, cutaway views illustrating the example fluid applicator assembly 600 employing another example transmission device 2000 disclosed herein to operate the example pump assembly 1400 of FIG. 14 via the actuator 606. In the illustrated example, the transmission device 2000 includes a first rack 2002, a second rack 2004 and a pinion 2006. In the illustrated example, the first rack 2002 extends from the actuator 606 into the housing 602 (e.g., substantially perpendicular to the longitudinal axis 616 of the housing 602). The example second rack 1904 is coupled to the piston 1412 and is oriented substantially perpendicular to the first rack 2002 (e.g., the second rack 2004 is substantially parallel to the longitudinal axis 616). The example pinion 2006 is rotatably coupled to the housing 602 and operatively coupled to the first rack 2002 and the second rack 2004.

When the example actuator 606 is moved from the unactuated position to the fully actuated position, the example fluid applicator assembly 600 of FIGS. 20A-20C dispenses a dose of the fluid onto the face 610 of the applicator 608. In the illustrated example, when the actuator 606 moves toward the fully actuated position, the first rack 2002 moves substantially linearly and rotates the pinion 2006 (e.g., clockwise in the orientation of FIGS. 19A-19B). As a result, the pinion 2006 drives the second rack 2004 and, thus, the piston 1412 toward the applicator 608, thereby operating the example pump assembly 1400 to dispense the fluid onto the face 610 of the applicator 608.

Referring to FIG. 20B, to enable the example pump assembly 1400 of FIGS. 20A-20C to be operated when the example piston 1412 is moved upward in the orientation of FIGS. 20A-B, the second portion 1406 of the example pump engine 1402 is fixedly coupled to the piston 1412. The first portion 1404 of the example pump engine 1402 is seated against the applicator 608 and movably coupled to the piston 1412. The second portion 1406 of the example pump engine 1402 is fixedly coupled to the fluid containment system 622, and the example fluid containment system 622 of FIGS. 20A-20C is movably coupled to the example housing 602. In the illustrated example, the spring 1416 is seated between the applicator 608 and the piston 1412 to bias or urge the piston 1412 away from the applicator 608. As a result, when the example piston 1412 moves toward the applicator 608, the piston 1412 moves the second portion 1406 of the example pump engine 1402 toward the applicator 608 and relative to the first portion 1404, thereby operating the example pump assembly 1400 and dispensing the fluid onto the face 610 of the applicator 608.

FIG. 20C illustrates the example fluid applicator assembly 600 of FIGS. 20A-B when the actuator 606 is in the fully actuated position. In the illustrated example, the piston 1412 and, thus, the fluid containment system 622 are moved (e.g., lifted) toward the applicator 608 from the unactuated position such that the spring 1416 is at least partially compressed. When the example actuator 606 is released, the example spring 1416 urges the piston 1412 away from the applicator 608 to enable the pump assembly 1400 to be subsequently operated.

FIGS. 21A-D are partial side, schematic views of another example fluid applicator assembly 2100 disclosed herein. In the illustrated example, the fluid applicator assembly 2100 includes a housing 2102 and a cap 2104 removably coupled to the housing 2102. In the illustrated example, the cap 2104 substantially surrounds and/or covers an applicator 2106 disposed on a first end 2108 of the housing 2102. The example fluid applicator assembly 2100 includes a fluid containment system 2110. The example fluid containment system 2110 of FIG. 21 includes a pliable pouch 2112 disposed in a casing or cage 2114. A pump assembly 2116 (e.g., the example pump assembly 1400 of FIG. 14) is disposed between the cage 2114 and a face or surface 2118 of the applicator 2106 onto which a fluid 2120 is to be dispensed via the pump assembly 2116. In the illustrated example, the pump assembly 2116 is fluidly coupled to the pouch 2112 and the face 2118 of the applicator 2106. The example pump assembly 2116 operates (e.g., pumps the fluid 2120 and/or enables the fluid 2120 to flow from the pouch 2112 onto the face 2118 of the applicator 2106) when the example pump assembly 2116 is compressed and/or subjected to a sufficient compressive force.

In the illustrated example, the fluid containment system 2110 is movably coupled to the housing 2102. A spring 2122 biases the cage 2114 toward the applicator 2106. In the illustrated example, the spring 2122 is seated between the cage 2114 and a second end 2124 of the housing 2102. The example cage 2114 includes a latch 2126 operatively coupled to an actuator 2128. The example actuator 2128 is disposed on the housing 2102 between the first end 2108 and the second end 2124. The example actuator 2128 may be a button, lever, etc. and/or may be implemented using the example actuator 702 of FIG. 7, the example actuator 800 of FIG. 8, the example actuator 900 of FIG. 9, the example actuator 1000 of FIG. 10, and/or any other actuator.

In the illustrated example, the cap 2104 substantially covers and/or surrounds the actuator 2128 when the cap is 2104 is coupled to the housing 2102. The example actuator 2128 is in an unactuated position and a one-way or shutoff valve 2130 substantially obstructs and/or seals an outlet through which the fluid 2120 is to be dispensed onto the face 2118 of the applicator 2106. In the illustrated example, an end 2132 of the latch 2126 extends through a slot 2134 of the housing 2102. When the cap 2104 is coupled to the housing 2102, a portion of the cap 2104 engages the end 2132 of the example latch 2126. As described in greater detail below, when the example cap 2104 is removed and the actuator 2128 is actuated, the latch 2126 disengages the actuator 2128 to enable the spring 2122 to move the cage 2114 toward the applicator 2118.

In the illustrated example, a linear ratchet 2136 is coupled to the cage 2114 and disposed between the cage 2114 and the second end 2124 of the housing 2102. A length of the example linear ratchet 2136 may be extended or shortened during operation between a minimum length and a maximum length. Thus, the example linear ratchet 2136 provides an obstruction between the cage 2114 and the second end 2124 of the housing to enable the cage 2114 to be spaced apart from the second end 2124 of the housing 2102 by at least the minimum length or distance. When the example cap 2104 is coupled to the housing 2102, the example linear ratchet 2136 is the minimum length.

FIG. 21B illustrates the example fluid applicator assembly 2100 of FIG. 21A with the cap 2104 removed or separated from the housing 2102.

FIG. 21C illustrates the example fluid applicator assembly 2100 of FIGS. 21A-B in which the latch 2126 is disengaged from the actuator 2128. In the illustrated example, when the actuator 2128 is moved from a first position to second position, the example latch 2126 disengages the actuator 2128. As a result, the example cage 2114 is substantially free to move relative to the housing 2102. The example spring 2122 urges the cage 2114 toward the applicator 2118 and moves the example cage 2114 from a third position to a fourth position. As a result, the cage 2114 operates the pump assembly 2116, and the pump assembly 2116 pumps a dose of the fluid 2120 from the pouch 2112 onto the face 2118 of the applicator 2106. The example latch 2126 moves with the cage 2114, and the end of 2132 extends out of the housing 2102 via the slot 2134.

FIG. 21D illustrates the example fluid applicator assembly 2100 of FIGS. 21A-C when the example cap 2104 is being coupled to the example housing 2102. In the illustrated example, when the example cap 2104 is moved to surround and/or cover (e.g., lowered onto) the applicator 2106, the cap 2104 engages the end 2132 of the latch 2126 extending outside of the housing 2102. As the example cap 2104 is further moved to engage the housing 2102, the cap 2104 drives the latch 2126 and, thus, the cage 2114 toward the second end 2124 of the housing 2102. As the latch 2126 moves toward second end 2124, the latch 2126 engages the actuator 2128 and substantially holds the latch 2126 and, thus, the cage 2114 in place.

As the example cap 2104 drives the cage 2114 toward the second end 2124 of the housing 2102, the linear ratchet 2136 compresses or shortens in length as the linear ratchet 2136 contacts the second end 2124 of the housing 2102. In some examples, a size of a dose of the fluid 2120 dispensed via the fluid applicator assembly of FIGS. 21A-D may be controlled based on the difference between the maximum length and the minimum length of the linear ratchet 2136. For example, a stroke (e.g., an amount of movement) of the cage 2114 may be proportional or related to the size of the dose dispensed via the pump assembly 2116. The minimum length of the linear ratchet 2136 may affect the stroke of the cage 2114 (e.g., the longer the minimum length, the shorter the stroke), and thus, the amount of the dose dispensed via the pump assembly 2116. In some examples, the linear ratchet 2136 provides feedback (e.g., tactile and/or auditory) to enable a patient to perceive when the cap 2104 is example linear ratchet 2135 has actuated to the minimum length and/or the cap 2104 is fully lowered onto the housing 2102.

FIG. 21E illustrates the example fluid applicator assembly 2100 having a second spring 2138. In the illustrated example, the second spring 2138 is seated between the cage 2114 and the applicator 2118 to urge the cage 2114 toward the second end 2124 of the housing 2102. In the illustrated example, the second spring 2138 applies a smaller force to the cage 2114 than the spring 2122. Thus, the example second spring 2138 does not actuate the cage 2114. The example second spring 2138 cooperates with the cap 2104 to move the cage 2114 toward the second end 2124 of the housing 2102 after the example fluid applicator assembly 2100 dispenses a dose of the fluid onto the face 2118 of the applicator 2118.

The example fluid applicator assembly 2100 of FIG. 21E also includes a counting mechanism or dose counter 2140 disclosed herein. As described in greater detail below, the counting mechanism 2140 indicates a number of actuations of the actuator 2128 and/or the cage 2114. The example counting mechanism 2140 may include a worm gear, a track, a window, a visual indicator, and/or any other component.

FIG. 21F illustrates the example fluid applicator assembly 2100 including a handle 2142 fixedly coupled to the cage 2114. The example handle 2142 enables the cage 2114 to be manually moved (e.g., by hand) toward the second end 2124 of the example housing 2102. For example, after a first dose of the liquid 2120 has been administered, the cage 2114 may be moved via the handle 2142 to enable the latch 2126 to engage the actuator 2128. The example actuator 2128 may be then be actuated to dispense a second dose of the fluid 2120 onto the face 2118 of the applicator 2106. In this manner, the example fluid applicator assembly 2100 may be used to administer a plurality of doses of the fluid without coupling the cap 2104 to the housing 2102 after each administration of the fluid 2120.

FIG. 21G illustrates the example fluid applicator assembly 2100 implemented using an alternative actuator 2144. In the illustrated example, the actuator 2144 is a cam pivotably coupled to the housing 2102 and the cage 2114. In the illustrated example, when the example actuator 2144 is pivoted about a pivot axis 2146, the example actuator 2144 moves the cage 2114 toward or away from the applicator 2106 depending on a direction of rotation of the actuator 2144. Thus, the example actuator 2144 may be used to prime (e.g., remove air) from the pump assembly 2116 and operate the pump assembly 2116 to dispense the fluid 2120. In some examples, an end 2148 of the actuator 2144 may engage a portion of the housing 2102 to hold or lock the example actuator 2144 in an unactuated position (e.g., a position from which the actuator 2144 is to move to operate the pump assembly 2116). By applying a sufficient force to the actuator 2144, the end 2148 may be disengaged from the housing 2102 and rotated to operate the example pump assembly 2116.

FIG. 21H is a perspective view of the example actuator 2144 of FIG. 21G. In the illustrated example, the actuator 2144 includes a second end 2150 opposite the first end 2148. In the illustrated example, the second end 2150 may contact or engage the housing 2102 when the actuator 2144 moves to an actuated position. In some examples, an amount of rotation between the unactuated position in which the first end 2148 engages the housing 2102 and the actuated position in which the second end 2150 engages the housing 2102 corresponds to a stroke of the cage 2114 and, thus, a size of a dose of the fluid 2120 dispensed via the example fluid applicator assembly 2100.

FIG. 22 is a side, schematic view of an example fluid applicator assembly 2200 disclosed herein. In the illustrated example, the fluid applicator assembly 2200 includes a housing 2202 and an applicator 2204 coupled to the housing 2202. The example applicator 2204 defines a surface 2206 onto which a fluid is to be dispensed from inside the example applicator assembly 2200 when an actuator 2208 moves from a first position to a second position.

In the illustrated example, the actuator 2208 is disposed on a side 2210 of the housing 2202 (e.g., between a first end 2212 and a second end 2214 of the housing 2202). The example actuator 2208 is slidably coupled to the housing 2202. In the illustrated example, the actuator 2208 moves along the side 2210 of the housing 2202 substantially parallel to a longitudinal axis 2216 of the housing 2202. The example actuator 2208 of FIG. 22 may be used to implement the example fluid applicator assembly 100 of FIGS. 1-2, the example fluid applicator assembly 100 of FIG. 3, the example fluid applicator assembly 400 of FIG. 4, the example fluid applicator assembly 500 of FIG. 5, the example fluid applicator assembly 600 of FIGS. 6A-6B, the example actuator 2128 of FIGS. 21A-F and/or any other example fluid applicator assembly.

In some examples, the housing 2202 is sized and shaped such that the example fluid applicator assembly 2200 may be held in one hand, and while the example fluid applicator assembly 2200 is being held in one hand, one or more fingers (e.g., a thumb) of the hand may be used to actuate the actuator 2208. As described in greater detail below, in some examples, the fluid applicator assembly 2200 includes a pump assembly operatively coupled to the actuator 2208.

FIG. 23 illustrates the example fluid applicator assembly 2200 of FIG. 22 employing a linear pump engine 2300 and an example transmission device 2302 operatively coupling the actuator 2208 to the linear pump engine 2300. In the illustrated example, the transmission device 2302 is a link or bracket fixedly coupling the actuator 2208 to at least a portion of the example linear pump engine 2300. When the example actuator 2208 moves (e.g., slides) toward the applicator 2204, the portion of the linear pump engine 2300 moves with the actuator 2208 via the transmission device 2302 to operate the linear pump engine 2300. When the example linear pump engine 2300 is operated, the linear pump engine 2300 pumps a fluid 2304 stored in a fluid containment system 2305 through a pump assembly 2306 including the linear pump engine 2300 and onto the face 2206 of the applicator 2204.

FIG. 24 illustrates the example fluid applicator assembly 2200 of FIG. 22 employing a ninety-degree pump engine 2400 and another example transmission device 2402 disclosed herein. In the illustrated example, a pump assembly 2404 including the pump engine 2400 is fluidly coupled to a fluid containment system 2406 and the face 2206 of the applicator 2204. The example transmission device 2402 includes a first ramp 2408 coupled to the first actuator 2208 and a second ramp 2410 coupled to a first portion 2412 of the pump engine 2400. The first portion 2412 of the pump engine 2400 is movable relative to a second portion 2414 of the pump engine 2400. In the illustrated example, when the actuator 2208 moves (e.g., slides) toward the applicator 2204, the first ramp 2408 engages the second ramp 2410 and moves the second ramp 2410 and the first portion 2412 of the pump engine 2400 substantially perpendicular to the longitudinal axis 2216 of the housing 2202. As a result, the pump engine 2400 pumps fluid 2416 from the fluid containment system 2406 onto the face 2206 of the applicator 2204.

FIGS. 25-29 are perspective views of the example fluid applicator assembly of FIG. 22 employing other example actuators 2500, 2600, 2700, 2800 disclosed herein. In the illustrated examples of FIGS. 25-29, the example actuators 2500, 2600, 2700, 2800 move in at least two directions to dispense fluid from inside the fluid applicator assembly 2200 onto the face 2206 of the applicator 2204.

The example actuator 2500 of FIG. 25 is a button that moves linearly (e.g., slides) from a first position (e.g., extending from the side 2210 of the housing 2202) toward the longitudinal axis 2216 to a second position (e.g., depressed into the housing 2202). Once the actuator 2500 is moved to the second position, the actuator 2500 moves linearly (e.g., slides) toward the applicator 2204 (e.g., substantially parallel to the longitudinal axis 2216) to a third position. In some examples, the actuator 2500 actuates a pump engine (e.g., the pump engine 1402 of FIG. 14, the pump engine 2300 of FIG. 23, the pump engine 2404 of FIG. 24 and/or any pump engine) disposed inside the housing 2202 when the actuator 2500 moves from the second position to the third position.

The example actuator 2600 of FIG. 26 includes a first button 2602 operatively coupled to a second button 2604. In the illustrated example, to dispense a fluid onto the face 2206 of the applicator, the first button 2602 and the second button 2604 actuate in a given sequence. In some examples, the first button 2602 moves linearly (e.g., slides) from a first position toward the applicator 2204 to a second position. If the first button 2602 is not in the second position, the example first button 2602 locks (e.g., engages) the second button 2604 in a third position to substantially prevent fluid from being dispensed via the fluid applicator assembly 2200. Once the example first button 2602 is in the second position, the second button 2604 is unlocked (e.g., disengaged from the first button 2602) and may be moved from the third position to a fourth position. In the illustrated example, a portion of the second button 2604 moves into the housing 2202 (e.g., perpendicular to the longitudinal axis 2216) as the second button 2604 moves from the third position to the fourth position. In some examples, the second button 2604 operates a pump engine (e.g., the example piston 1100 of FIG. 11, the example pump engine 1202 of FIG. 2, the example pump engine 1308 of FIG. 13, the example pump engine 1402 of FIG. 14, and/or any other pump engine) disposed inside the housing 2202 when the second button 2604 moves from the third position to the fourth position.

The example actuator 2700 of FIG. 27 is a button that actuates by sliding from a first position toward the applicator 2204 to a second position. When the example actuator 2700 is in the second position, the actuator 2700 moves from the second position toward the longitudinal axis 2216 to a third position. In some examples, the actuator 2700 operates a pump engine (e.g., the example piston 1100 of FIG. 11, the example pump engine 1202 of FIG. 2, the example pump engine 1308 of FIG. 13, the example pump engine 1402 of FIG. 14, and/or any other pump engine) disposed inside the housing 2202 when the actuator 2700 moves from the second position to the third position.

The example actuator 2800 of FIG. 28 includes a first button 2802 and a second button 2804 movably coupled to the first button 2802. When the second button 2804 is disposed in a first position, the second button 2804 obstructs and/or locks the first button 2802 to prevent movement of the first button 2802 relative to the housing 2202. In the illustrated example, the first button 2802 defines a slot 2806. A portion of the example second button 2804 extends through the slot 2806, and the example second button 2804 is movable along the slot 2806. In the illustrated example, when the example second button 2804 moves from the first position to a second position via the slot 2806, the first button 2802 is free to move relative to the housing 2202 and, thus, may be actuated to operate a pump engine (e.g., the example piston 1100 of FIG. 11, the example pump engine 1202 of FIG. 2, the example pump engine 1308 of FIG. 13, the example pump engine 1402 of FIG. 14, and/or any other pump engine) disposed inside the housing 2202. In the illustrated example, the first button 2802 is movable toward or away from the longitudinal axis 2216 relative to the housing 2202.

FIG. 29 illustrates another example fluid applicator assembly 2900 disclosed herein. In the illustrated example, the fluid applicator assembly 2900 includes a housing 2902 having a first end 2904 opposite a second end 2906. An applicator 2908 is coupled to the first end 2904, and an actuator 2910 (e.g., a button) is movably coupled to the second end 2906. In the illustrated example, the actuator 2910 is linearly movable toward and/or away from the applicator 2908 to dispense a fluid onto a surface 2912 of the applicator 2908.

FIG. 30 is a side, schematic view illustrating an example pump engine 3000 and transmission device 3008 of the fluid applicator assembly 2900 of FIG. 29. In the illustrated example, the pump engine 3000 is a piston slidably coupled to a casing 3004 of a fluid containment system 3006. The example pump engine 3000 is operatively coupled to the actuator 2910 via the transmission device 3008. In the illustrated example, the transmission device 3008 functions as a cam screw or ratchet. In the illustrated example, the transmission device 3008 includes a first toothed cam 3010 coupled to the actuator 2910. The example transmission device 3008 of FIG. 30 also includes a second toothed cam 3012 coupled to a shaft 3014. In the illustrated example, the pump engine 3000 is rotatably coupled to the shaft 3014 via a lead screw 3016. The second cam 3012 is operatively coupled to the first cam 3010.

When the example actuator 2910 is actuated, the actuator 2910 operates the pump engine 3000 via the transmission device 3008. For example, when the example actuator 2910 moves toward the applicator 2908, the first toothed cam 3010 applies a radial force to the second toothed cam 3012 to rotate the second toothed cam 3012 relative to the first toothed cam 3010. As a result, the shaft 3014 rotates relative to the pump engine 3000 to move the pump engine 3000 via the threads of the lead screw 3016 toward the applicator 2908.

FIG. 31 illustrates another example fluid applicator assembly 3100 disclosed herein. In the illustrated example, the fluid applicator assembly 3100 includes a housing 3102 and an applicator 3104 movably coupled to an end 3106 of the housing 3102. The example applicator 3104 of FIG. 31 moves substantially along a longitudinal axis 3108 of the housing 3102 to dispense fluid from inside the fluid applicator assembly 3100 onto a surface 3110 of the applicator 3104.

FIGS. 32A and 32B are perspective views of another example fluid applicator assembly 3200 disclosed herein having a housing 3202 and an actuator 3204 rotatably coupled to the housing 3202. Referring to FIG. 32A, in the illustrated example, the fluid applicator assembly 3200 includes a cap 3206 removably coupled to a first end 3208 of the housing 3202. The example actuator 3204 of FIG. 32A is rotatably coupled to a second end 3210 of the housing 3202 opposite the first end 3208. The example cap 3206 of FIG. 32A is shown as being transparent to illustrate the relationship between various components disclosed herein. However, the cap 3206 may be opaque. As illustrated in FIG. 32A, an applicator 3212 is visible through the cap 3206. In the illustrated example, the applicator 3212 is fixedly coupled to the first end 3208 of the housing 3202. When the example cap 3206 is coupled to the housing 3202, the cap 3206 substantially surrounds and/or covers the applicator 3212.

In FIG. 32B, the example cap 3206 is removed and/or separated from the example fluid applicator assembly 3200 and the actuator 3204 is in a semi-actuated position. When the example cap 3206 of FIG. 32A-B is removed or separated from the example fluid applicator assembly 3200, a dose of a fluid (e.g., a liquid, foam, and/or gel such as, for example, a Testosterone Replacement Therapy fluid and/or any other fluid) may be dispensed onto a surface or face 3214 and administered to an application site of a patient by contacting the face 3214 of the applicator 3212 and, thus, the fluid to the application site. In the illustrated example, the fluid is stored inside the fluid applicator assembly 3200. The example actuator 3204 of FIG. 32B is a knob, which may be rotated from a first position (FIG. 32A) to a second position (e.g., 180 degrees from the first position, 165 degrees from the first position, and/or any other position) relative to the housing 3202 to dispense the fluid onto the face 3214 of the applicator 3212. In the illustrated example, the actuator 3204 rotates about a central, longitudinal axis 3215 of the housing 3202. In other examples, the actuator 3204 rotates about other axes of rotation. In the illustrated example, the actuator 3204 is has a cross-sectional shape substantially similar to a cross-sectional shape of the example housing 3202 adjacent the second end 3210.

In the illustrated example, the actuator 3204 defines a third end 3216 of the example fluid applicator assembly 3200 and is accessible via sides 3218, 3220, 3222, 3224 of the fluid applicator assembly 3200 and/or the third end 3216 of the example fluid applicator assembly 3200. As described in greater detail below, the example actuator 3204 is operatively coupled to a pump assembly disposed inside the example fluid applicator assembly 3200. In some examples, the actuator 3204 provides tactile and/or audible feedback (e.g., an audible clicking sound) when the example actuator 3204 is moved (e.g., rotated) to and/or in the second position (e.g., to indicate that the actuator 3204 is in the second position). For example, when the actuator 3204 reaches the second position, the actuator 3204 engages or disengages a pawl and/or other device that produces a sound (e.g., the clicking sound) to indicate that the example actuator 3204 is in and/or has reached the second position. In some examples, a force to be applied to the actuator 3204 to rotate the actuator from the first position to the second position is less than seven pounds. In other examples, other amounts of force are to be applied to the actuator 3204 to rotate the actuator 3204.

FIG. 33 is a perspective, schematic view of the example fluid applicator assembly 3200 of FIG. 32 employing another actuator 3300 disclosed herein. In the illustrated example, the actuator 3300 is rotatably coupled to the housing 3202. The example actuator 3300 of FIG. 33 is a dial disposed in a notch 3302 defined by the example housing 3202 of FIG. 33. In the illustrated example, the notch 3302 extends from the first side 3218 to the second side 3222 and is spaced apart from the third side 3320 and the fourth side 3324. Portions of the example actuator 3300 extend out of the notch 3302 via the first side 3218 and the second side 3222. Thus, the example actuator 3300 of FIG. 33 is accessible via the first side 3218, the second side 3222 and/or the end 3210 of the example housing 3202.

FIG. 34 is a perspective, schematic view of the example fluid applicator assembly 3200 of FIG. 32 employing another example actuator 3400 disclosed herein. In the illustrated example, the actuator 3400 is rotatably coupled to the housing 3202 and slidably coupled to the housing 3202. For example, the actuator 3400 is slidable from a first position to a second position farther from the applicator 3212 than the first position. When the example actuator 3400 is in the second position, the example actuator 3400 is rotatable relative to the housing 3202. In some examples, the actuator 3400 of FIG. 34 is substantially locked against rotation when the actuator 3400 is in the first position.

FIG. 35 is a perspective, schematic view of the example fluid applicator assembly 3200 of FIG. 32 employing another example actuator 3500 disclosed herein. In the illustrated example, the actuator 3500 includes a knob 3502 and a button 3504. In the illustrated example, the button 3504 is disposed on a side 3506 of the knob 3502 and slidably coupled to the knob 3502. When the example button 3504 is in a first position, the button 3504 engages the housing 3202 to substantially prevent the knob 3502 from rotating relative to the housing 3202. When the example button 3504 is in a second position, the button 3504 disengages the housing 3202, and the example knob 3502 is free to rotate relative to the housing 3202. In the illustrated example, the button 3504 moves away from the applicator 3212 to move from the first position to the second position.

FIG. 36 is a perspective, schematic view of the example fluid applicator assembly 3200 of FIG. 32 employing another example actuator 3600 disclosed herein. In the illustrated example, the actuator 3600 includes a knob 3602 and a button 3604. In the illustrated example, the button 3604 is disposed on a side 3606 of the knob 3602 and is slidably coupled to the knob 3602. When the example button 3604 is in a first position, the button 3604 engages the housing 3202 to substantially prevent the knob 3602 from rotating relative to the housing 3202. When the example button 3604 is in a second position, the button 3604 disengages the housing 3202, and the example knob 3602 is free to rotate relative to the housing 3202. In the illustrated example, the button 3604 moves into the knob 3602 (e.g., the button 3604 is depressed) to move from the first position to the second position.

FIG. 37 is a perspective, schematic view of the example fluid applicator assembly 3200 of FIG. 32 employing another example actuator 3700 disclosed herein. In the illustrated example, the actuator 3700 includes a knob 3702 and a button 3704. In the illustrated example, the button 3704 is disposed in a cavity 3706 defined by the knob 3702. Thus, the example button 3704 is accessible via the third end 3216 of the fluid applicator assembly 3200. In the illustrated example, the button 3704 is pivotably coupled to the knob 3702 and/or the housing 3202. When the example button 3704 is in a first position, the button 3704 engages the housing 3202 to substantially prevent the knob 3702 from rotating relative to the housing 3202. When the example button 3604 is in a second position, the button 3704 disengages the housing 3202, and the example knob 3702 is free to rotate relative to the housing 3202. In the illustrated example, the button 3704 moves in a rocking or see-saw motion to move from the first position to the second position.

FIG. 38 is a perspective, schematic view of the example fluid applicator assembly 3200 of FIG. 32 employing another example actuator 3800 disclosed herein. In the illustrated example, the actuator 3800 includes a knob 3802 and a button 3804. In the illustrated example, the button 3804 is disposed in a cavity 3806 defined by the knob 3802. Thus, the example button 3804 is accessible via the third end 3216 of the fluid applicator assembly 3200. In the illustrated example, the button 3804 is slidably coupled to the knob 3802 and/or the housing 3202. When the example button 3804 is in a first position, the button 3804 engages the housing 3202 to substantially prevent the knob 3802 from rotating relative to the housing 3202. When the example button 3804 is in a second position, the button 3804 disengages the housing 3202, and the example knob 3802 is free to rotate relative to the housing 3202. In the illustrated example, the button 3804 moves into the knob 3802 (e.g., is depressed) to move from the first position to the second position.

Although the example actuator 3204 is used in conjunction with the following examples, the example actuator 3500 of FIG. 35, the example actuator 3600 of FIG. 36, the example actuator 3700 of FIG. 37, the example actuator 3800 of FIG. 38, and/or any other actuator may be used to implement the following examples.

FIG. 39 is a side, schematic view of the example fluid applicator assembly 3200 employing an example pump engine 3900 operatively coupled to the actuator 3204. In the illustrated example, a fluid containment system 3902 is disposed inside the example housing 3202. The example fluid containment system 3902 includes a pliable pouch 3904 operatively coupled to the pump engine 3900. In the illustrated example, the pump engine 3900 is a piston. An example transmission device 3906 operatively couples the pump engine 3900 to the actuator 3204. In the illustrated example, the transmission device 3906 includes a shaft or lead screw 3908 fixedly coupled to the actuator 3204. The example shaft or lead screw 3908 is rotatably coupled to the pump engine 3900 via threads 3910. In the illustrated example, when the example actuator 3204 is rotated relative to the housing 3202, the pump engine 3900 moves along the shaft or lead screw 3908 toward the applicator 3212. In some examples, the pump engine 3900 compresses, squeezes, rolls, wrinkles, and/or folds the pouch 3904 to pump fluid 3912 from the pouch 3904 onto the face 3214 of the fluid applicator 3212.

FIG. 40 is a side, schematic view of the example fluid applicator assembly 3200 employing another example pump engine 4000 operatively coupled to the actuator 3204. In the illustrated example, the example fluid applicator assembly 3200 includes a fluid containment system 4002 movably coupled to the housing 3202. The example pump engine 4000 is a linear pump disposed between the applicator 3212 and the fluid containment system 4002. In the illustrated example, the actuator 3204 is operatively coupled to the fluid containment system via a cam 4004. When the example actuator 3204 is rotated relative to the housing 3202, the cam 4004 urges the fluid containment system 4002 toward the applicator 3212 to actuate the pump engine 4000. In some examples, a distance that the cam 4004 moves the fluid containment system 4002 during one half of a revolution (e.g., 180 degrees) of the actuator 3204 is proportional to a size of a dose of a fluid 4006 dispensed onto the face 3214 of the applicator 3212.

FIG. 41 is a side, schematic view of the example fluid applicator assembly 3200 employing another example pump engine 4100 operatively coupled to the actuator 3204. In the illustrated example, the example fluid applicator assembly 3200 includes a fluid containment system 4102 fixedly coupled to the housing 3202. The example pump engine 4100 is a ninety-degree pump disposed between the applicator 3212 and the fluid containment system 4102. In the illustrated example, the actuator 3204 is operatively coupled to the pump engine 4100 via a cam 4104 and an arm 4106. In the illustrated example, the cam 4104 is fixedly coupled to the actuator 3204, and the arm 4106 is fixedly coupled to the pump engine 4100. When the example actuator 3204 is rotated relative to the housing 3202, the cam 4104 moves the arm 4106 to actuate the pump engine 4000. In some examples, a distance that the cam 4104 moves the arm 4106 during one half of a revolution (e.g., 180 degrees) of the actuator 3204 is proportional to a size of a dose of a fluid 4108 dispensed onto the face 3214 of the applicator 3212.

FIG. 42 is a cross-sectional view of the example fluid applicator assembly 3200 of FIG. 38 employing the example pump assembly 1400 of FIGS. 18B and 20B. The first portion 1404 of the example pump engine 1402 is seated against the applicator 608 and movably coupled to the piston 1412. The example piston 1412 is movable relative to the housing 3202 and fixedly coupled to the second portion 1406 of the pump engine 1402. The second portion 1406 of the example pump engine 1402 is fixedly coupled to a fluid containment system 4200, and the example fluid containment system 4200 is movably coupled to the example housing 3202. Thus, in the illustrated example, the fluid containment system 4200, the second portion 1406 of the pump engine 1402 and the piston 1412 move together relative to the housing 3202. When the fluid containment system 4200 moves toward the applicator 3212, the second portion 1406 of the pump engine 1402 moves relative to the first portion 1404, thereby operating the example pump assembly 1400 and dispensing the fluid onto the face 3214 of the applicator 1312. In the illustrated example, the spring 1416 is seated between the applicator 3212 and the piston 1412 to bias or urge the piston 1412 and, thus, the fluid containment system 4200 away from the applicator 3212.

In the illustrated example, the fluid containment system 4200 of FIG. 42 includes a casing or cage 4202 and a pliable pouch 4204 disposed in the cage 4202. In some examples, the cage 4202 supports and/or protects the example pouch 4204. In some examples, the pouch 4204 is formed via one or more layers or sheets (e.g., foil sheets). In some examples, ends of the pouch 4204 are coupled (e.g., via a heat sealing) to a plate or cap (e.g., an injection molded cap) to seal and/or provide rigidity to the pouch 4204. In other examples, the pouch 4204 is coupled to the first fluid interface 1408 and sealed via heat sealing (e.g., along a first side, a second side, a first end and a second end). In some examples, the pouch 4204 is coupled directly to the first fluid interface 1408 via a heat sealing operation. In other examples, the pouch is manufactured, sealed and/or supported via other techniques.

The example cage 4202 includes a neck 4206 extending from cage 4202 toward the third end 3216 of the fluid applicator assembly 3200. In the illustrated example, the knob 3802 is rotatably coupled to the neck 4206. The example neck 4206 of FIG. 42 includes two ramps 4208, 4209 to engage two protrusions 4210, 4211, respectively, of a shaft 4212 extending from the knob 3802 toward the neck 4206. In the illustrated example, a ratchet 4213 is coupled to the knob 3802. In the example of FIG. 42, the cage 4202 is in an unactuated position in which the cage 4202 is supported by (e.g., seated against) a base 4214. In some examples, the base 4214 cooperates with the neck 4206 to align the example cage 4202 in the housing 3202. In the illustrated example, when the example button 3804 is in the first position, the button 3804 engages the neck 4206 to substantially prevent the knob 3802 from rotating relative to the housing 3202. When the example button 3804 is in the second position and the knob 3802 rotates relative to the housing 3202, the protrusions 4210, 4211 of the knob 3802 engage the ramps 4208, 4209 of the neck 4206 and urges the fluid containment system 4200 toward the applicator 3212. As a result, the pump engine 1402 pumps fluid from the pouch 4204 onto the face 3214 of the applicator.

The example actuator 3800 also includes a ring 4216 operatively coupled to the knob 3802. As described in greater detail below, the ring 4216 includes a plurality of visual indicators, which may be used to indicate a count of revolutions of the knob 3802 relative to the housing 3202.

FIG. 43 is an exploded view of a portion of the example fluid applicator assembly 3200 of FIG. 42. In the illustrated example, the ramps 4208, 4209 of the neck 4206 are spiral or helical shaped. In other examples, the ramps 2408, 4209 are other shapes. The example knob 3802 of FIG. 43 includes a first window or aperture 4300. In some examples, the ring 4216 is visible through first window 4300.

FIG. 44 is an exploded view of the example actuator 3800. In the illustrated example, the ratchet 4213 is ring-shaped and includes a plurality of teeth or ramps 4400 to engage the teeth or ramps of the shaft 4212. In the illustrated example, the teeth 4400 of the ratchet 4213 and the teeth of the shaft 4212 are oriented such that rotation of the shaft 4212 in a first direction urges the cage 4202 toward the applicator 3212. If a torque is applied in a second direction opposite the first direction, one or more of the teeth 4400 of the ratchet 4213 engage (e.g., bind with) the teeth of the shaft 4212 such that the knob 3802 is substantially prevented from rotating in the second direction.

In the illustrated example, the teeth of the shaft 4212 and/or the ramps 4208, 4209 are spaced apart and/or the ramps 4208, 4209 are angled such that the cage 4202 moves from the unactuated position to an actuated position and back to the unactuated position within one half of a revolution (e.g., 180 degrees) of the knob 3802 relative to the housing 3202. Thus, in the illustrated example, when the knob 3802 is rotated one half of a revolution (e.g., 180 degrees), the fluid applicator assembly 3200 dispenses one dose of the fluid.

The example ring 4216 of FIG. 44 is received in an aperture 4402 of the base 4214 in communication with the first window 4300 via a second window or aperture 4403 of the base 4214. In the illustrated example, the ring 4216, the base 4214, and the ratchet 4213 are disposed around the stem shaft 4212 extending from the knob 3802 toward the neck 4206.

FIG. 45 is a top view illustrating an example counting mechanism 4500 disclosed herein. The example counting mechanism 4500 of FIG. 45 includes the shaft 4212 of the knob 3802, the base 4214 and the ring 4216. In the illustrated example, the base 4214 defines a substantially circular ring gear 4502. A geared rim 4504 of the example ring 4216 is engaged with the ring gear 4502. In the illustrated example, the ring 4216 is elliptical or oblong and elastically deformable. A portion of the example shaft 4212 is also elliptical or oblong. In the illustrated example, the shaft 4212 is engages an inner surface 4506 of the ring 4216. As a result, when the example knob 3802 rotates in a first direction, the shaft 4212 elastically deforms the ring 4216 and the ring 4216 rotates eccentrically about the ring gear 4502. Based on a gear ratio between the geared rim 4504 of the ring 4216 and the ring gear 4502 of the base 4214, the ring 4216 rotates a given amount per revolution of the knob 3802.

FIG. 46 is an exploded view of the example counting mechanism 4500 of FIG. 45. In the illustrated example, the ring 4216 includes a plurality of visual indicators 4600 disposed around a circumference of the ring 4216 such that when the ring 4216 rotates, the visual indicators 4600 are visible through the first window 4300 and the second window 4403. In the illustrated example, the visual indicators 4600 are numbers. In other examples, the visual indicators 4600 are other types of visual indicators such as, for example colors, words, and/or any other visual indicator that may be used to identify, for example, a number does applied, remaining doses, etc.

FIG. 47 is an exploded view of the example counting mechanism 4500 of FIG. 45 in which the example ring 4216 includes an aperture 4700 to receive a locking pin 4800 (FIG. 48). The example aperture 4700 is disposed on the ring 4216 such that after a given number of revolutions of the knob 3802 (e.g., thirty 180 degree rotations or 15 revolutions), the aperture 4700 aligns with the locking pin 4800.

FIG. 48 is a partial, cross-sectional view of the example actuator 3800 of FIG. 42 including a spring-loaded locking pin 4800. In the illustrated example, the locking pin 4800 is movably coupled to the base 4214 and extends through an aperture 4802 of the base 4214. In the illustrated example, an end 4804 of the locking pin 4800 engages a side 4806 of the ring 4216. The example locking pin 4800 is biased toward the ring 4216 via a spring 4808. When the example ring 4216 rotates a given number of rotations, the locking pin 4800 aligns with the aperture 4700, and the spring 4218 urges the locking pin 4800 into the aperture 4700. As a result, the locking pin 4800 substantially prevents further rotation of the knob 3802.

FIG. 49 is a cross-sectional, side view of the example fluid applicator assembly 3200 of FIG. 42 having the spring 1416 disposed inside the neck 4206 of the cage 4202 and seated between the knob 3802 and the cage 4202. In the illustrated example, the shaft 4212 of the knob 3802 engages the neck 4206 to pull the cage 4202 away from the applicator 3212 as the knob 3802 is rotated from a first position (e.g., an unactuated position) to a second position (e.g., a position less than 180 degrees from the first position such as, for example, 165 degrees). As a result, the spring 1416 extends (e.g., loads) as the knob 3802 moves from the first position to the second position. When the knob 3802 reaches the second position, the shaft 4212 disengages the neck 4206 and the spring 1416 urges the cage 4202 towards the applicator 3212. As a result, the pump assembly 1400 pumps a dose of a fluid onto the surface 3214 of the applicator 3212. The knob 3802 may then be rotated from the second position to a third position (e.g., 180 degrees from the first position). In this manner, the example actuator 3800 of FIG. 49 may be used to dispense one or more doses of a fluid.

FIGS. 50A-50B illustrate an example valve 5000 disclosed herein. Although the example valve 5000 is shown and discussed in conjunction with the example fluid application assembly 600 of FIG. 6, the example valve 5000 may be employed by any example fluid applicator assembly disclosed herein. The example valve 5000 is ball valve fixedly coupled to the tube 1414. In some examples, the valve 5000 is constructed from and/or at least partially composed of Nitrile, stainless steel, FKM (e.g., a fluoroelastomer), rubber and/or other materials. When the pump assembly 1400 is not operating (e.g., not pumping) (FIG. 50A), the valve 5000 is in a closed position in which the valve 5000 plugs, obstructs and/or seals the outlet 615 to substantially prevent fluids, debris (e.g., dirt) and/or any other potential containments from entering the fluid applicator assembly 600 via the outlet. In some examples, when the valve 5000 is in the closed position, the valve 5000 also reduces and/or substantially prevents evaporation of the fluid in the fluid applicator assembly 600. As shown in FIG. 50B, when the example pump assembly 1400 is operating, the valve 5000 is in an open position in which the valve 5000 is spaced apart from the outlet 615, and allows fluid to flow around the valve 5000 and onto the face 610 of the applicator 608.

FIGS. 51A-51B illustrate another example valve 5100 disclosed herein. The example valve 5000 is a poppet valve. In some examples, the valve 5100 is constructed from and/or at least partially composed of Nitrile, FKM, rubber, stainless steel and/or other materials. In FIG. 51A, the example valve 5100 is in a closed position in which the valve 5100 substantially preventing prevent fluids, debris (e.g., dirt) and/or any other potential containments from entering the fluid applicator assembly 600 via the outlet. In some examples, when the valve 5100 is in the closed position, the valve 5100 also reduces and/or substantially prevents evaporation of the fluid in the fluid applicator assembly 600. As shown in FIG. 51B, when the example pump assembly 1400 is operating, the valve 5100 is in an open position in which the valve 5100 is spaced apart from the outlet 615, and fluid may flow around the valve 5100 and onto the face 610 of the applicator 608.

FIG. 52 illustrates another example valve 5200 disclosed herein. The example valve 5200 is an umbrella valve. In some examples, the valve 5200 is constructed from and/or at least partially composed of Nitrile, FKM, rubber, stainless steel and/or other materials. In the illustrated example, the valve 5200 is movably coupled to the applicator 608. When fluid flows from the pump assembly 1400, the fluid moves the example valve 5200 from a closed position in which the valve 5200 seals and/or obstructs the outlet 615 to an open position in which the valve 5200 allows fluid to flow onto the face 610 of the applicator 608.

FIGS. 53A and 53B illustrate another example valve 5300 disclosed herein. In some examples, the valve 5300 is constructed from and/or at least partially composed of Nitrile, stainless steel, FKM, rubber and/or other materials. The example valve 5300 is a duckbill valve. In some examples, the valve 5300 is disposed inside the tube 1414. When fluid flows through the tube 1414, the fluid contacts the valve 5300 and opens a gate or flap 5302 of the valve 5300. As a result, the fluid flows into and through the valve 5300. In some examples, when the flap 5302 is closed, the valve 5300 reduces and/or substantially prevents evaporation of the fluid in the fluid applicator assembly 600.

FIG. 54 illustrates another example valve 5400 disclosed herein, which may be used to prevent fluids, debris (e.g., dirt) and/or other potential contaminants from entering the example fluid applicator assemblies disclosed herein. In some examples, the valve 5400 is constructed from and/or at least partially composed of Nitrile, FKM, rubber, stainless steel and/or other materials. In some examples, when the valve 5400 is in the closed position, the valve 5400 reduces and/or substantially prevents evaporation of the fluid in the fluid applicator assembly 600. In the illustrated example, the valve 5400 includes a cap 5402 including one or more slits 5404. When fluid is flowed into the example cap 5402, the fluid urges the slits 5404 to widen, and the fluid flows through the valve 5400. In some examples, the cap is at least partially made and/or composed of an elastomeric material. In some examples, the cap includes a permeable membrane.

FIG. 55 is a perspective view of another example fluid applicator assembly 5500 disclosed herein. In the illustrated example, the fluid applicator assembly 5500 includes a housing 5502 and an applicator 5504 removably coupled to the housing 5502. A cap 5506 is removably coupled to the applicator 5504. In the illustrated example, a portion of the applicator 5504 is shown as being transparent to illustrate the relationship between various components disclosed herein. However, the applicator 5504 may be opaque. As illustrated in FIG. 55, an actuator 5508 is visible through the transparent portion of the applicator 5504.

FIG. 55B illustrates the example fluid applicator assembly 5500 having the applicator 5504 decoupled from the housing 5502, and the cap 5506 decoupled from the applicator 5504. When the example applicator 5504 is decoupled from the housing 5502, and the cap 5506 of FIG. 55 is decoupled from the applicator 5504, a dose of a fluid (e.g., a liquid, foam, and/or gel such as, for example, a Testosterone Replacement Therapy fluid and/or any other fluid) may be dispensed onto the applicator 5504 via the actuator 5508. The example fluid applicator 5504 may then be used to apply the fluid to an application site (e.g., skin) of a patient by contacting a surface 5510 of the applicator 5504 supporting the fluid to the application site, thereby transferring the fluid from the applicator 5504 to the application site.

In the illustrated example, the fluid is stored inside the housing 5502. In the illustrated example, the actuator 5508 is a button movably coupled to a first end 5512 of the housing 5502. The example actuator 5508 movable between a first position and a second position. When the example actuator 5508 moves from the first position the second position, the example housing 5502 dispenses a dose of the fluid onto the applicator 5510 via an outlet 5514. In the illustrated example, the actuator 5508 moves substantially linearly from the first position to the second position toward the first end 5512 of the housing 5502. Other example actuators move in other manners (e.g., rotatably, substantially perpendicular to a central, longitudinal axis of the housing 5502, away from the first end 5512 of the housing 5502, and/or in other manners).

FIGS. 55C and 55D are perspective views of the example fluid applicator assembly of FIGS. 55 and 56 in which the applicator 5504 and the actuator 5508 have shapes different than illustrated in FIGS. 55A and 55B. In the illustrated example, the applicator 5502 has a handle 5516 having a flange or guard 5518 to facilitate holding and/or maneuvering the example applicator. The example actuator 5508 of FIGS. 55C and 55D includes a spout 5520.

FIG. 56 is an exploded view of the example fluid applicator assembly 5500 of FIG. 55A-55B including an example pump assembly 5600 and an example fluid containment system 5602 disclosed herein. In the illustrated example, the pump assembly 5600 is fluidly coupled to the fluid containment system 5602 and the actuator 5508. The example pump assembly 5600 may include an airless pump and/or any other type of pump. In some examples, the pump assembly 5600 is the example pump assembly 1400 of FIG. 14. In the illustrated example, a portion of the example pump assembly 5600 is disposed in a collar 5503 of the housing 5502

In the illustrated example, the fluid containment system 5602 includes a portion of the housing 5502 and a piston 5604. In the illustrated example, the housing 5502 is substantially cylindrical and the piston 5604 is disposed inside and slidably coupled to the housing 5502. In some examples, the housing 5502 and the piston 5604 define a chamber (e.g., an airtight or vacuum chamber) in which the fluid is held and/or stored. A cap or cover 5606 is coupled to the housing 5502 to cover and/or seal an end 5608 of the housing 5502.

FIG. 57 illustrates the example fluid applicator assembly 5500 of FIGS. 55A and 55B having an alternative pump assembly 5700 and fluid containment system 5702 disclosed herein. In the illustrated example, the fluid containment system 5702 of FIG. 57 includes a casing or cage 5703 and a pouch 5704 (e.g., a pouch, a bag, etc.). In the illustrated example, the pouch 5704 holds and/or stores the fluid. The example pouch 5704 is disposed inside the example cage 5703. In some examples, the pouch 5704 is pliable (e.g., elastically deformable, non-elastically deformable, flexible, etc.) and may be at least partially made from and/or composed of plastic, fabric, metal foil and/or any other pliable material. In some examples, the pouch 5704 substantially conforms to a shape of the cage 5703. The example pump assembly 5700 of FIG. 57 is in fluid communication with the pouch 5704 and the actuator 5508.

FIGS. 58-60 illustrate example counting mechanisms 5800, 5900, 6000. Although the following examples are described in conjunction with the example fluid applicator assembly 600 of FIG. 6, the example counting mechanism 5800, 5900, 6000 may be employed by any of the example fluid applicators disclosed herein. Further, the example counting mechanisms 5800, 5900, 6000 may be in addition to or as an alternative to other counting mechanisms.

The example counting mechanism 5800 of FIG. 58 includes indication gear 5802, and a worm gear 5804, a shaft 5806, and a driven gear 5808 operatively coupled the shaft 5806. In the illustrated example, the actuator 606 is operatively coupled to the driven gear 5808. In the illustrated example, when the actuator 606 moves from an actuated position to an unactuated position, the driven gear 5808 rotates to rotate the shaft 5806, which rotates the worm gear 5804 to drive the indication gear 5802 a given number of rotations. In the illustrated example, the applicator 608 includes a window or aperture 5810 through which the indication gear 5802 is visible. In some examples, the indication gear 5802 includes one or more visual indicators that may be visible through the window 5810 to indicate, for example, a number of dosages dispensed via the example fluid applicator assembly 600.

The example counting mechanism of FIG. 59 includes a track 5902 coupled to a wheel 5903. An indicator 5904 is movably coupled to the track 5902 to follow a path defined by the track 5902. In the illustrated example, the track 5902 is spiral-shaped and extends away from the wheel (e.g., out of the page in the orientation of FIG. 59). The example indicator 5904 extends through a slot 5906 in the housing 602 of the example fluid applicator assembly 600. The example indicator 5904 is movable toward or away from the applicator 608 via the slot 5906 in the illustrated example. The actuator 606 is operatively coupled to the wheel 5903 such that when the actuator 606 moves from the actuated position to the unactuated position, the wheel rotates a given amount, thereby moving the indicator 5904 a given distance along the track 5902 and the slot 5906. As a result, a position of the example indicator 5904 along the slot 5906 indicates a number of actuations of the actuator 606 and/or an amount of fluid remaining in the example fluid applicator assembly 600. In some examples, the indicator 5904 is visible through a window defined by the housing 602 and/or the applicator 608. In other examples, the indicator 5904 extends out of a slot 5906 of the housing 602 and/or the applicator 608. In some examples, the indicator 5904 moves toward the applicator 608 when the example actuator 606 is actuated. In other examples, the indicator 5904 moves away from the applicator 608.

The example counting mechanism of FIG. 60 includes a first gear 6002 and a second gear 6004. The example first gear 6002 and the example second gear 6004 include a plurality of visual indicators 6006 (e.g., numbers). The example counting mechanism 6000 is operatively coupled to the actuator 606 and disposed in the housing 602. In the illustrated example, the housing 602 defines a window 6008 through which one visual indicator 6006 of the first gear 6002 and one visual indicator 6006 of is visible. The example visual indicators 6006 cooperate (e.g., both are used) to indicate a remaining amount of fluid in the fluid applicator assembly 600.

FIG. 61 illustrates an example cap 6100 disclosed herein, which may employed by any of the example fluid applicator assemblies disclosed herein. In the illustrated example, the cap 6100 includes a plurality of first teeth 6102 to engage a plurality of second teeth 6104 of a housing 6103 of a fluid applicator assembly 6106. In the illustrated example, the cap 6100 is resiliently flexible. Opposing sides 6108, 6110 of the example cap 6100 are moved inwardly (e.g., toward each other) to disengage the first teeth 6102 from the second teeth 6104. When the first teeth 6102 and the second teeth 6104 are out of engagement, the example cap 6100 may be removed or decoupled from the housing 6103.

FIG. 62 illustrates a plurality of example applicators 6200, 6202, 6204, 6206, 6208, 6210, 6212, 6214, 6216, 6218, 6220, 6222, 6224, 6226, 6228, 6230 disclosed herein, which may be used to implement any of the example applicators described above. The example applicators 6200, 6202, 6204, 6206, 6208, 6210, 6212, 6214, 6216, 6218, 6220, 6222, 6224, 6226, 6228, 6230, have a plurality of sizes and/or shapes (e.g., rounded, circular, elliptical, oval, concave, convex, dome-shaped, etc.). Each of the applicators 6200, 6202, 6204, 6206, 6208, 6210, 6212, 6214, 6216, 6218, 6220, 6222, 6224, 6226, 6228, 6230 has a surface 6232, 6234, 6236, 6238, 6240, 6242, 6244, 6246, 6248, 6250, 6252, 6254, 6256, 6258, 6260, 6262, onto which a fluid is to be dispensed and contacted against an applicant site of a patient.

Each of the surfaces 6232, 6234, 6236, 6238, 6240, 6242, 6244, 6246, 6248, 6250, 6252, 6254, 6256, 6258, 6260, 6262 include a one or more dimples, recesses, annuluses protrusions, ridges, concavities, notches, depressions, sockets, and/or other features and/or characteristics that facilitate fluid stability on the surfaces (e.g., hold the fluid on the surface), facilitate transfer of the fluid to the application site, facilitate retention of the fluid on the surfaces 6232, 6234, 6236, 6238, 6240, 6242, 6244, 6246, 6248, 6250, 6252, 6254, 6256, 6258, 6260, 6262 (e.g., when the surfaces 6232, 6234, 6236, 6238, 6240, 6242, 6244, 6246, 6248, 6250, 6252, 6254, 6256, 6258, 6260, 6262 face at least partially away from Earth or in a generally upward, vertical direction), substantially prevent or reduce liquidation of a gel and/or decrease in viscosity of the fluid, enhance patient comfort, facilitate massaging of the application site, etc. In some examples, portions of the surfaces 6232, 6234, 6236, 6238, 6240, 6242, 6244, 6246, 6248, 6250, 6252, 6254, 6256, 6258, 6260, 6262 are substantially smooth (e.g., have a surface variation of less than or approximately 0.002 inches (e.g., a surface having a texture corresponding to SPI B1, MT11030 and/or other textures). In some examples, smoothness of the surfaces 6232, 6234, 6236, 6238, 6240, 6242, 6244, 6246, 6248, 6250, 6252, 6254, 6256, 6258, 6260, 6262 facilitates retention of the fluid on the surfaces 6232, 6234, 6236, 6238, 6240, 6242, 6244, 6246, 6248, 6250, 6252, 6254, 6256, 6258, 6260, 6262. For example, the smoothness of the surfaces 6232, 6234, 6236, 6238, 6240, 6242, 6244, 6246, 6248, 6250, 6252, 6254, 6256, 6258, 6260, 6262 enables the surfaces 6232, 6234, 6236, 6238, 6240, 6242, 6244, 6246, 6248, 6250, 6252, 6254, 6256, 6258, 6260, 6262 to provide sufficient surface tension between the fluid and the surfaces 6232, 6234, 6236, 6238, 6240, 6242, 6244, 6246, 6248, 6250, 6252, 6254, 6256, 6258, 6260, 6262 to retain the fluid on the surfaces 6232, 6234, 6236, 6238, 6240, 6242, 6244, 6246, 6248, 6250, 6252, 6254, 6256, 6258, 6260, 6262 (e.g., when the surfaces 6232, 6234, 6236, 6238, 6240, 6242, 6244, 6246, 6248, 6250, 6252, 6254, 6256, 6258, 6260, 6262 are facing at least partially away from Earth or a generally upward, vertical direction).

In some examples, the applicators 6200, 6202, 6204, 6206, 6208, 6210, 6212, 6214, 6216, 6218, 6220, 6222, 6224, 6226, 6228, 6230 are at least partially composed of polypropylene. In some examples, the applicators 6200, 6202, 6204, 6206, 6208, 6210, 6212, 6214, 6216, 6218, 6220, 6222, 6224, 6226, 6228, 6230 are substantially rigid or inflexible. In other examples, the applicators 6200, 6202, 6204, 6206, 6208, 6210, 6212, 6214, 6216, 6218, 6220, 6222, 6224, 6226, 6228, 6230 are deformable (e.g., resiliently or nonresiliently).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1-21. (canceled)

22. An apparatus, comprising:
a housing;
a fluid containment system disposed inside the housing, the fluid containment system including a cage and a fluid container disposed inside the cage, the cage including a ramp;
a pump assembly disposed inside the housing and fluidly coupled to the fluid containment system;
an applicator coupled to a first end of the housing, the applicator defining an outlet and having a surface to be in contact with an application site on a person, the surface in fluid communication with the pump assembly via the outlet; and
a one-way actuator rotatably coupled to a second end of the housing opposite the first end, the actuator to engage the ramp, wherein rotation of the actuator in a first direction from a first position to a second position is to move the cage toward the applicator via the ramp, and rotation of the actuator in the first direction from the second position to a third position is to move the cage away from the applicator, at least one of movement of the cage toward or away from the applicator is to operate the pump assembly to dispense a dose of the fluid onto the surface.

23. The apparatus of claim 22, wherein the fluid container comprises a pliable pouch.

24. The apparatus of claim 23, wherein the pump assembly comprises an airless pump to pump the fluid from the pouch onto the surface of the applicator.

25. The apparatus of claim 22, wherein the actuator is operatively coupled to an elastically deformable ring that is to eccentrically rotate when the actuator rotates, the ring including a plurality of visual indicators.

26. The apparatus of claim 25 further comprising a base coupled to the housing to support the cage, the base defining an aperture to receive the ring.

27. The apparatus of claim 26, wherein the base includes a first window and the actuator includes a second window aligned with the first window, one of the plurality of visual indicators visible through the first window and the second window.

28. The apparatus of claim 22, wherein the cage includes a neck extending from the cage away from the applicator, the ramp disposed on the neck.

29. The apparatus of claim 22, wherein the actuator comprises a cam, the cam to engage the ramp to move the cage toward the applicator.

30. The apparatus of claim 22, further comprising a ratchet operatively coupled to the actuator, the ratchet to permit rotation of the actuator in the first direction and to prevent rotation of the actuator in a second direction opposite the first direction.

31. An apparatus, comprising:
a housing;
a cage disposed inside the housing and slidably coupled to the housing;
a pouch disposed in the cage;
a pump disposed in the housing, the pump in fluid communication with the pouch;
an applicator fixedly coupled to the housing, the applicator having a surface in fluid communication with the pump via an outlet defined by the applicator, the surface to contact an application site on a person to transfer the fluid from the surface to the application site; and
an actuator rotatably coupled to the housing, the actuator including a protrusion to urge the cage toward the applicator to cause the pump to dispense a portion of the fluid onto the surface.

32. The apparatus of claim 31, further comprising a one-way valve in fluid communication with the pump and the outlet, the one-way valve in an unactuated position to prevent liquid from entering the housing via the outlet, the one-way valve in an actuated position to enable the fluid to be dispensed onto the surface.

33. The apparatus of claim 31, wherein the cage includes a curved ramp to engage the protrusion, the protrusion to drive the cage via the ramp when the actuator rotates from a first position to a second position.

34. The apparatus of claim 31, wherein the actuator is disposed on a first end of the housing, and the applicator is disposed on a second end of the housing opposite the first end.

35. The apparatus of claim 31, wherein the cage and the pouch are to move toward and away from the applicator during a stroke of the actuator.

36. The apparatus of claim 31 further comprising a ring-shaped ratchet having a plurality of teeth, the ratchet operatively coupled to the actuator to prevent rotation of the actuator in a first direction and enable rotation of the actuator in a second direction.

37. The apparatus of claim 31 further comprising a button operatively coupled to the actuator, the button in a first position to prevent rotation of the actuator, the button in a second position to enable rotation of the actuator.

38. An apparatus, comprising:
a housing;
an applicator including a surface defining an outlet;
a fluid container disposed inside the housing and slidably coupled to the housing, the fluid container to store a fluid;
a ramp coupled to the fluid container;
a pump disposed inside the housing; and
an actuator rotatably coupled to the housing to engage the ramp, rotation of the actuator to slide the fluid container relative to the applicator via the ramp to actuate the pump to pump the fluid from the fluid container, the fluid to be supported on the surface.

39. The apparatus of claim 38 further comprising:
a base coupled to the housing to support the fluid container, the base defining a first gear;
an elastically deformable ring engaging the actuator and having a second gear to engage the first gear, the ring having a plurality of visual indicators, wherein rotation of the actuator is to rotate the ring about an axis of rotation of the actuator, and one of the plurality of visual indicators is to be visible through a window of the actuator.

40. The apparatus of claim 39, wherein the actuator includes an oblong portion, the oblong portion engaging the ring to deform the ring.

41. The apparatus of claim 38, wherein the surface includes a concavity to support the fluid on the surface.
